(19) United States
(12) Patent Application Publication
(10) Pub. No.: US 2025/0384579 A1
(43) Pub. Date: Dec. 18, 2025

(54) EXTRACTION MACHINE CONTROL DEVICE, EXTRACTION MACHINE CONTROL PROGRAM, AND EXTRACTION MACHINE SYSTEM

(71) Applicant: FANUC CORPORATION, Yamanashi (JP)

(72) Inventor: Jun WADA, Yamanashi (JP)

(21) Appl. No.: 18/878,900

(22) PCT Filed: Aug. 29, 2022
(86) PCT No.: PCT/JP2022/032447

§ 371 Date: Dec. 26, 2024

(51) Int. Cl. G06T 7/73; G06T 1/00; G06T 7/00; G06T 7/593

(52) U.S. Cl. CPC G06T 7/74; G06T 1/0014; G06T 7/001; G06T 7/593; G06T 2207/10012; G06T 2207/30164

(57) ABSTRACT

A control device for controlling an extraction machine to extract an arbitrary object from a plurality of objects including at least one object on which extraction positions are set includes: a data extraction unit which extracts data from a sensor that measures the appearances of a plurality of objects; a data processing unit which processes the data from the data extraction unit, controls an extraction machine, associates, for each of the extraction positions, the data at the time of accessing the object with the extraction position, and stores the associated result in a list; an extraction position selection unit which selects an extraction position of the object extracted by the extraction machine on the basis of an output of the list; and an extraction machine control unit which controls the extraction machine and extracts the object on the basis of the output from the extraction position selection unit.

### RELATED APPLICATIONS

The present application is a National Phase of International Application No. PCT/JP2022/032447 filed Aug. 29, 2022.

### FIELD

The present disclosure relates to an extraction machine controller, an extraction machine control program, and an extraction machine system.

### BACKGROUND

In recent years, robots (extraction machines) have been used in various industries to grasp and extract workpieces (objects). One application for such robots is for the extraction of individual workpieces from a plurality of workpieces randomly arranged in a container, i.e., for bulk workpiece extraction.

In bulk extraction applications, the positions and orientations of the plurality of workpieces within the container are detected based on measurement results from a 3D sensor such as a stereo camera, and the workpieces are extracted using an end effector (hand unit) of the robot.

For example, there has been proposed a system in which information regarding failed extractions, information regarding interference of the robot by peripheral devices during extraction, and surrounding information resulting from extraction are stored in a blacklist, and the robot is controlled based on the blacklist. The blacklist is, for example, a list of the plurality of workpieces in which workpieces that the robot is not allowed to access are written.

Specifically, when a robot performs an extraction operation on a certain workpiece and fails to extract it, since the workpiece for which extraction has failed is likely to have shifted from its measured position due to the extraction failure, it is stored in a blacklist. For workpieces around the workpiece stored in the blacklist, the robot is forbidden from performing the extraction operation until a subsequent measurement is performed using, for example, a 3D sensor.

In other words, if the extraction operation of the robot fails, the workpiece for which extraction failed is stored in a blacklist, and in subsequent extraction operations, the area around the workpiece stored in the blacklist is removed from the extraction target until certain conditions are met.

By managing the extraction of workpieces based on the blacklist in this manner, the number of times that the robot attempts to extract workpieces that are likely to fail to be extracted may be lowered, or workpieces that have fallen over may be avoided, enabling the efficient performance of workpiece extraction.

Conventionally, various robot control technologies have been proposed to enable more efficient workpiece extraction.

### CITATION LIST

### Patent Literature

[PTL 1] Japanese Unexamined Patent Publication (Kokai) No. 2018-144161
[PTL 2] Japanese Unexamined Patent Publication (Kokai) No. 2008-087074

### SUMMARY

### Technical Problem

As described above, for example, storing information regarding workpieces for which extraction has failed in a blacklist and controlling a robot based on the blacklist to improve the efficiency of workpiece extraction has been proposed.

In recent years, there has been research and development into a system in which a plurality of extraction positions are set for one workpiece, and a robot performs the operation of extracting the workpiece based on one of the extraction positions. Specifically, among the plurality of extraction positions set for one workpiece, even if extraction fails at one extraction position, extraction may be possible at another extraction position, which is believed to improve the efficiency of workpiece extraction.

However, if, for example, the information regarding the workpiece for which extraction has failed is stored in a blacklist and extraction control is performed, extraction may not be attempted for other extraction positions of the same workpiece. Furthermore, not only may the workpiece not be extracted, but access such as moving the workpiece to a position where it may be extracted or changing the loading state of the workpiece with the end effector may not be performed. As a result, it becomes difficult to efficiently extract the workpiece.

An object of the present disclosure is to provide an extraction machine controller, an extraction machine control program, and an extraction machine system with which workpiece extraction may be efficiently performed.

### Solution to Problem

According to an embodiment of the present disclosure, there is provided an extraction machine controller for controlling an extraction machine and extracting an arbitrary object from a plurality of objects including at least one object on which a plurality of extraction positions are set. This extraction machine controller includes a data acquisition unit, a data processing unit, an extraction position selection unit, and an extraction machine control unit.

The data acquisition unit is configured to acquire data from a sensor that measures an outer shape of the plurality of objects. The data processing unit is configured to process the data from the data acquisition unit and store in a list, for each of the extraction positions, data used for controlling the extraction machine to access the object in association with the extraction positions. The extraction position selection unit is configured to select an extraction position of an object to be extracted by the extraction machine based on an output of the list. The extraction machine control unit is configured to control the extraction machine to extract the object based on an output of the extraction position selection unit.

The objects and advantages of the invention will be realized and obtained by means of the elements and combinations specifically indicated in the claims. Both the foregoing general description and the following detailed description are exemplary and explanatory and do not limit the present invention as described in the claims.

### BRIEF DESCRIPTION OF DRAWINGS

FIG. 1 is a view schematically illustrating an industrial robot system as an example of an extraction machine system according to an embodiment of the present invention.

FIG. 2 is a block diagram depicting each function of the industrial robot system depicted in FIG. 1.

FIG. 3 is a view depicting an example of a list (blacklist) in the industrial robot system depicted in FIG. 2.

FIG. 4 is a flowchart explaining an example of processing in a first example of an extraction machine control program according to the present embodiment.

FIG. 5 is a flowchart explaining an example of a first process in the flowchart depicted in FIG. 4.

FIG. 6 is a flowchart explaining an example of a second process in the flowchart depicted in FIG. 4.

FIG. 7 is a flowchart explaining an example of a third process in the flowchart depicted in FIG. 4.

FIG. 8 is a flowchart explaining an example of a fourth process in the flowchart depicted in FIG. 4.

FIG. 9 is a flowchart explaining an example of processing in a first modification example of the extraction machine control program according to an embodiment.

FIG. 10 is a flowchart explaining a main part of processing in a second modification example of the extraction machine control program according to an embodiment.

FIG. 11 is a flowchart explaining an example of processing in a second example of an extraction machine control program according to the present embodiment.

FIG. 12 is a view depicting an example of a list (extraction position list) in the industrial robot system depicted in FIG. 2.

FIG. 13 is a flowchart explaining an example of a first process in the flowchart depicted in FIG. 11.

FIG. 14 is a flowchart explaining an example of a second process in the flowchart depicted in FIG. 11.

FIG. 15 is a flowchart explaining an example of a third process in the flowchart depicted in FIG. 11.

FIG. 16 is a flowchart explaining an example of a fourth process in the flowchart depicted in FIG. 11.

FIG. 17 is a flowchart explaining an example of processing in a third example of the extraction machine control program according to the present embodiment.

FIG. 18 is a view depicting another example of a list (extraction position list) in the industrial robot system depicted in FIG. 2.

FIG. 19 is a flowchart explaining an example of a first process in the flowchart depicted in FIG. 17.

FIG. 20 is a flowchart explaining an example of a second process in the flowchart depicted in FIG. 17.

FIG. 21 is a flowchart explaining an example of a third process in the flowchart depicted in FIG. 17.

FIG. 22 is a flowchart (part 1) explaining an example of a fourth process in the flowchart depicted in FIG. 17.

FIG. 23 is a flowchart (part 2) explaining an example of a fourth process in the flowchart depicted in FIG. 17.

FIG. 24 is a flowchart explaining an example of a process for selecting data to be extracted from an extraction position list in accordance with priority in the extraction machine control program of the third example depicted in FIG. 17.

FIG. 25 is a flowchart explaining another example of the process for selecting data to be extracted from the extraction position list in accordance with priority in the extraction machine control program of the third example depicted in FIG. 17.

### DESCRIPTION OF EMBODIMENTS

The embodiments of the extraction machine controller, the extraction machine control program, and the extraction machine system according to the present invention will be described in detail below with reference to the accompanying drawings. In the drawings, identical or similar constituent elements have been assigned the same or similar reference numerals. Furthermore, the embodiments described below do not limit the technical scope of the invention and the meanings of the terms described in the claims.

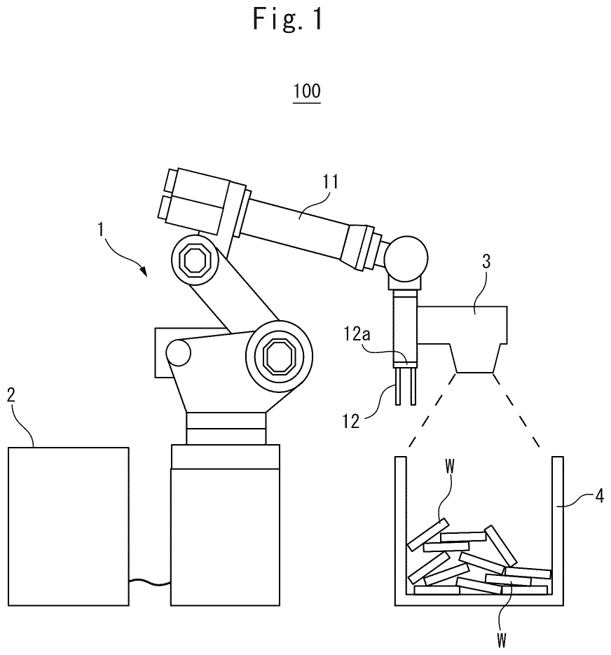

FIG. 1 is a view depicting an industrial robot system as an example of the extraction machine system according to the present embodiment. The extraction machine system according to the present embodiment may be applied to an industrial robot system for extracting workpieces that are randomly arranged (randomly stacked) with an industrial robot, but is not limited to industrial robot systems. Specifically, the extraction machine system according to the present embodiment may be widely applied not only to robot systems such as industrial robots and collaborative robots, but also to extraction machine systems which include the function of extracting various objects with various machines.

In FIG. 1, reference numeral 1 represents an industrial robot (extraction machine), 2 represents a robot controller (extraction machine controller), 3 represents a 3D sensor (three-dimensional measurement instrument), 4 represents a container, 100 represents an industrial robot system (mechanical system), and W represents a workpiece (object).

As depicted in FIG. 1, the industrial robot system 100 as an example of the extraction machine system according to the present embodiment comprises an industrial robot 1, a robot controller 2, and a 3D sensor 3. The industrial robot 1 is controlled by the robot controller 2, and is configured to extract (grasp) a plurality of workpieces W randomly arranged in a container 4 one-by-one with a hand unit (end effector: gripping unit) 12 provided at the tip of an arm 11.

The 3D sensor 3 is composed of, for example, a stereo camera, and is attached near the hand unit 12. Images of an outer shape of the plurality of workpieces W in the container 4 captured by the 3D sensor 3 are output to the robot controller 2. Specifically, the output of the 3D sensor 3 is input to the robot controller 2, the positions and orientations of the workpieces W are detected (calculated), and, for example, a plurality of extraction positions are set for one workpiece W.

The hand unit 12 is, for example, a pneumatic gripper for gripping the workpiece W by air pressure, and whether or not the hand unit 12 has successfully gripped (extracted) the workpiece W may be determined based on the measurement results of an air pressure sensor 12a provided in the hand unit 12. It should be noted that the determination of whether or not the workpiece W has been successfully extracted is not limited to being based on the measurement results of the air pressure sensor 12a, and may also be based on, for example, the output of various contact sensors or the state of the workpiece W in an image captured by a camera.

The 3D sensor 3 is attached near the moving hand unit 12 of the industrial robot 1, but it may also be affixed to, for example, a ceiling above the industrial robot 1, and the affixed 3D sensor 3 may measure (photograph) the outer shape of the plurality of workpieces W in the container 4. Furthermore, the 3D sensor 3 is not limited to a stereo camera, and various sensors may be adopted as long as they may measure the three-dimensional shapes of the plurality of workpieces, etc.

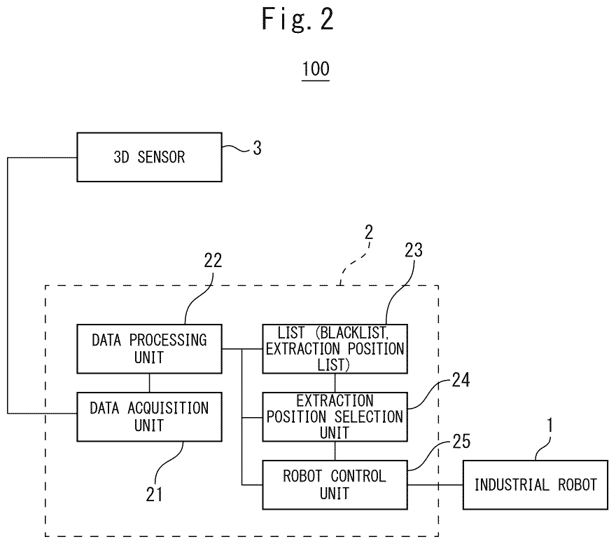

FIG. 2 is a block diagram depicting each function of the industrial robot system depicted in FIG. 1. As depicted in FIG. 2, the robot controller 2 controls the industrial robot 1 to perform operations such as extracting the workpiece W, and comprises a data acquisition unit 21, a data processing unit 22, a list 23, an extraction position selection unit 24, and a robot control unit 25. It should be noted that the extraction machine control program according to the present embodiment, which will be described in detail later, is executed by, for example, an arithmetic processing device constituted by the data processing unit 22, the extraction position selection unit 24, and the robot control unit in the robot controller 2.

The list 23 is a memory (storage unit) and is used as a blacklist or extraction position list, which will be described in detail later. Specifically, the list 23 may be applied, for example, as a blacklist in which extraction positions that the industrial robot 1 is not allowed to access are stored among a plurality of extraction positions. Furthermore, the list 23 may also be applied, for example, as an extraction position list in which an item of priority (extraction order) is further provided for each extraction position. It should be noted that, in the following description, for example, extraction positions that are not stored in the blacklist are omitted because they are outside the subject of the present embodiment.

The data acquisition unit 21 acquires, for example, appearance data of the plurality of workpieces W randomly piled (disorderly arranged) in the container 4 measured by the 3D sensor 3. The data processing unit 22 receives and processes the data from the data acquisition unit 21, and for each extraction position, stores data when controlling the industrial robot 1 to access the workpiece W in a list 23 in association with the extraction position. For at least one workpiece W among the plurality of workpieces W in the container 4, a plurality of extraction positions are set for extraction by the hand unit 12.

The extraction position selection unit 24 selects an extraction position of the workpiece W to be extracted by the industrial robot 1 based on the output of the list 23, and the robot control unit 25 controls the industrial robot 1 based on the output of the extraction position selection unit 24 to extract the workpiece W. Specifically, the extraction position selection unit 24 selects an extraction position of the workpiece W to be extracted (accessed) by the industrial robot 1 based on the output of the list 23. The robot control unit 25 then, for example, controls the industrial robot 1 to access the extraction position selected by the extraction position selection unit 24 and perform an extraction operation to extract the workpiece W having that extraction position.

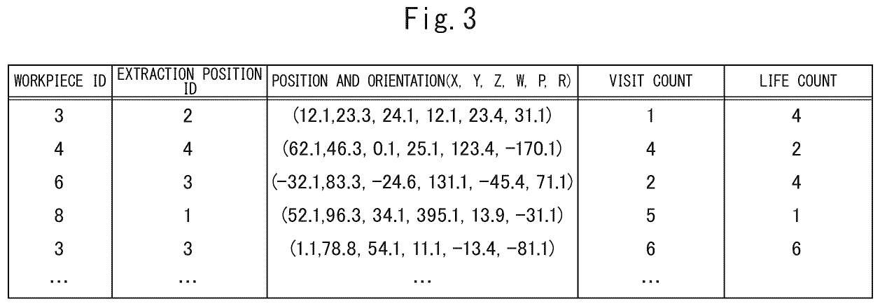

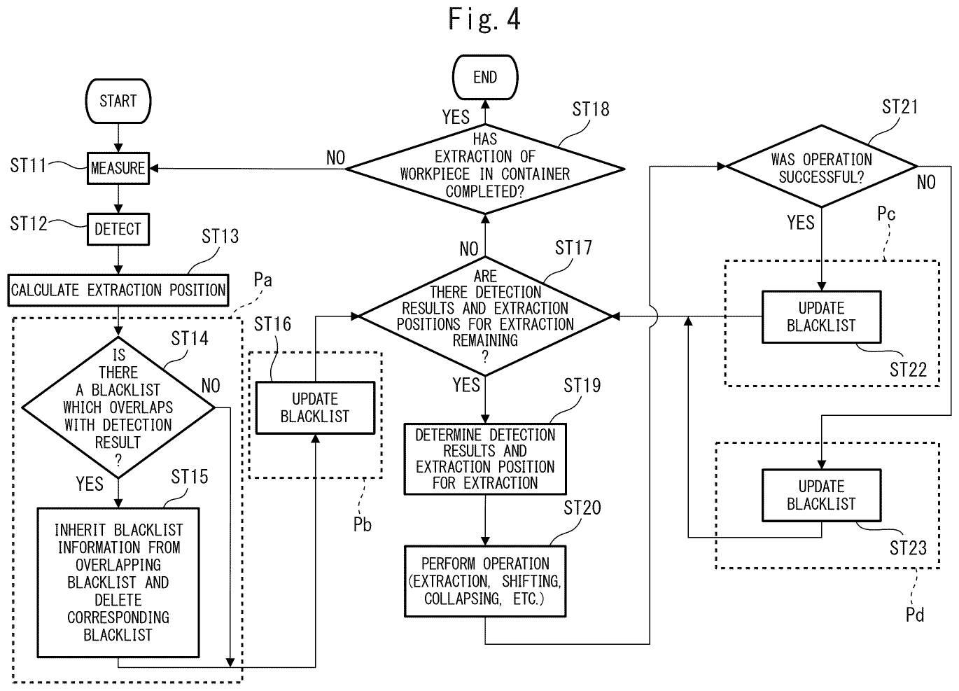

FIG. 3 is a view depicting an example of a list (blacklist) in the industrial robot system depicted in FIG. 2, and depicts an example of a blacklist used in the processing of a first example of the extraction machine control program according to the present embodiment, which will be described in detail with reference to FIG. 4 to FIG. 8.

As depicted in FIG. 3, the blacklist 23 is classified by items such as “workpiece ID”, “extraction position ID”, “position and orientation (X, Y, Z, W, P, R)”, “visit count”, and “life count”. This blacklist is also used to perform processing such as deleting a stored (written) extraction position from the blacklist when the extraction position moves due to an extraction operation of a workpiece or the like, or when an extraction operation of a workpiece has been performed a predetermined number of times. As a result, workpiece extraction processing may be efficiently performed.

The “workpiece ID” is an identification number (Identification) for each of the plurality of workpieces W in the container 4, and “extraction position ID” is an identification number for each of the plurality of extraction positions set for the workpiece W. Specifically, as depicted in FIG. 3, there are two locations where “workpiece ID” is “3”, which indicate the same workpiece W. It should be noted that, for the same workpiece W, an “extraction position ID” of “2” indicates the second extraction position, and an “extraction position ID” of “3” indicates the third extraction position.

“Position and orientation (X, Y, Z, W, P, R)” refers to the three-dimensional position data (X, Y, Z) and orientation data (W, P, R) at the extraction position set for each workpiece W. The three-dimensional position data (X, Y, Z) indicates the distance (for example, mm) from the reference point (origin: for example, a corner of the container), and the orientation data (W, P, R) indicates the rotation angle (for example, degrees) on each axis (X-axis, Y-axis, Z-axis).

The “visit count” is a count value that is increased in accordance with the number of visits after being stored in the blacklist 23. Specifically, the “visit count” is incremented by “1” each time the extraction position of any workpiece W is stored in the blacklist 23, and an extraction position that has reached a predetermined value (for example, “5”) is deleted from the blacklist. It should be noted that an extraction position deleted from the blacklist may be returned to, for example, a list (extraction position list) for storing extraction positions that are not stored in the blacklist.

The “life count” is a count value that is decreased in accordance with the number of accesses after being stored in the blacklist 23. Specifically, the “life count” is decreased by “1” from a predetermined value (for example, “10”) for the extraction position of any workpiece W stored in the blacklist 23 each time the workpiece W is accessed, and an extraction position the lift count of which becomes zero or less is deleted from the blacklist 23. It should be noted that an extraction position deleted from the blacklist may be returned to a list (extraction position list) for storing, for example, extraction positions that are not stored in the blacklist. Thus, as will be described in detail later, the contents of the blacklist 23 change in accordance with the extraction operation (shifting operation, collapsing operation) of the workpiece W by the extraction machine (industrial robot) 1, etc.

For example, in an industrial robot system 100 for executing the extraction machine control program of the first example, the data processing unit 22 processes data acquired by the data acquisition unit 21, and controls the extraction operation of the workpiece W by the industrial robot 1 via the blacklist 23, the extraction position selection unit 24, and the robot control unit 25. In the extraction machine system (industrial robot system) 100 according to the present embodiment, the blacklist 23 is configured to be managed for each extraction position of the workpiece W.

For example, when two extraction positions, a first extraction position and a second extraction position, are set for one workpiece W, if an extraction attempt at the first extraction position fails, the first extraction position is stored (written) in the blacklist 23. Then, in the next and subsequent extraction accesses, the first extraction position is excluded from extraction targets (extraction candidates) until certain conditions are met.

The second extraction position set for the same workpiece W as the first extraction position stored in the blacklist 23 is set is not stored in the blacklist 23. Specifically, the second extraction position of the workpiece W the first extraction position of which is stored in the blacklist is accessible without being excluded from the extraction target, like other extraction positions not stored in the blacklist. Furthermore, for example, the robot controller 2 may check for interference, and with respect to an extraction operation for a picking position where interference may occur, the extraction position may be considered as a failure before the extraction operation is performed, and stored in the blacklist 23. Furthermore, in addition to an extraction position determined to interfere with an extraction position where an actual extraction operation has been performed and failed, for example, if the movement path to the extraction position includes a position outside the operating range of the robot or a singular point position, it is preferable to store such an extraction position in the blacklist since the extraction position may not be reached.

In the foregoing, the application of the present embodiment is not limited to the operation of extracting the workpiece W in the narrow sense, but may also be attempted to perform operations after a failed extraction operation, such as shifting or collapsing the workpiece W. Specifically, in the present description, the operation of extracting the workpiece W is an operation performed by accessing the extraction position in the broad sense, and includes shifting and collapsing operations.

The shifting operation is, for example, an operation in which the hand unit 12 of the industrial robot 1 moves the workpiece W, when the hand unit 12 accesses an extraction position set for the workpiece W and performs an extraction operation, but fails to extract the workpiece due to the shallow grip. The collapsing operation is, for example, an operation in which the hand unit 12 of the industrial robot 1 applies an external force to an arbitrary workpiece W (pushes the workpiece W) to collapse the surrounding stacked workpieces, when the workpiece may not be extracted by accessing all of the extraction positions set for the workpiece W. The collapsing operation is also usually performed by accessing one of the extraction positions set for the workpiece W.

In this manner, the extraction machine system according to the present embodiment makes it possible to efficiently access workpieces W for which plurality of extraction positions are set. It should be noted that, in order to apply the present embodiment, it is not necessary to set plurality of extraction positions for all of the workpieces W in the container 4, and it is possible to apply the present embodiment even if only one extraction position is set for some of the workpieces W.

Next, an example of an extraction machine control program according to the present embodiment executed by the arithmetic processing device (the data processing unit 22, the extraction position selection unit 24, etc.) will be described in detail.

FIG. 4 is a flowchart explaining an example of processing in the first example of the extraction machine control program according to the present embodiment. As depicted in FIG. 4, when an example of processing in the first example of the extraction machine control program according to the present embodiment starts, in step ST11, for example, the appearances of the plurality of workpieces (W) in the container (4) are measured by a 3D sensor (3), and the process proceeds to step ST12, where the position and orientation (x, y, z, w, p, r) of each workpiece are detected (calculated), and the process proceeds to step ST13.

In step ST13, the extraction position for each workpiece is calculated, and the process proceeds to step ST14. In step ST13, if possible, a plurality of extraction positions are calculated for one workpiece. As described above, it is not necessary to calculate (set) two or more extraction positions for each workpiece in the container in step ST13, and for example, a workpiece with only one extraction position may be included.

In step ST14, it is determined (comparison determination) whether or not there is a blacklist (23) that overlaps with the detection result, and if it is determined that there is a blacklist that overlaps with the detection result (YES), the process proceeds to step ST15. In step ST15, the blacklist information is inherited from the overlapping blacklist, the corresponding blacklist is deleted, and the process proceeds to step ST16 (second process Pb).

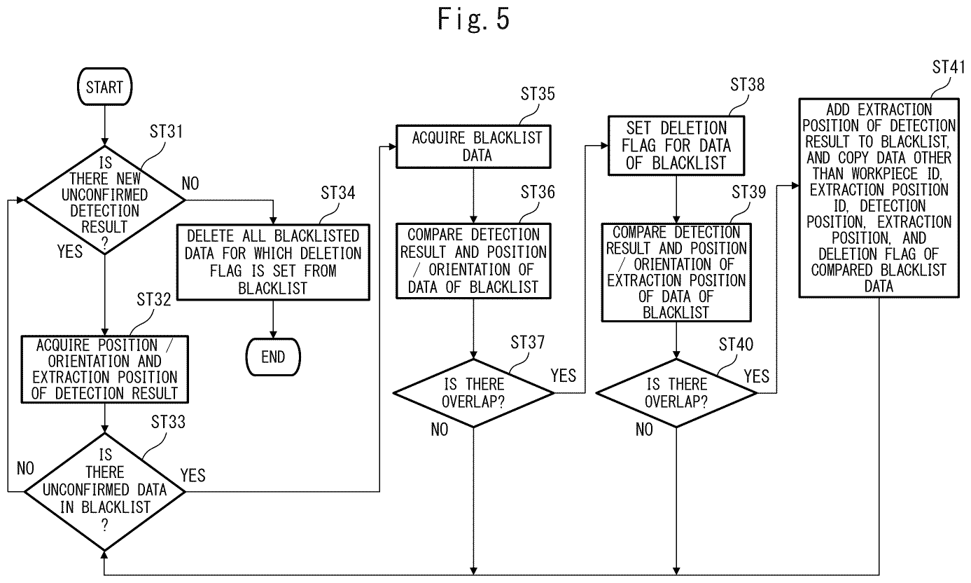

Specifically, if an extraction position based on a new measurement overlaps with one already stored in a blacklist, the data stored in the blacklist is inherited and/or used (in other words, the data stored in the blacklist is inherited, used, or both inherited and used). Conversely, if it is determined in step ST14 that there is no blacklist that overlaps with the detection result (NO), the process proceeds directly to step ST16. Steps ST14 and ST15 constitute a first process Pa. An example of the first process Pa will be described in detail later with reference to FIG. 5.

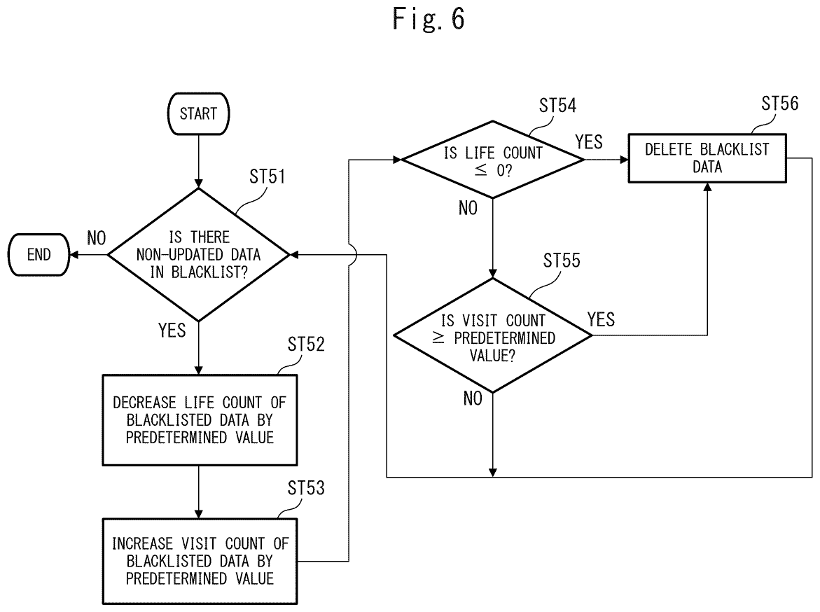

Next, in step ST16, the blacklist is updated, and the process proceeds to step ST17 to determine whether or not there are any detection results and extraction positions for extraction. If it is determined in step ST17 that there are any detection results and extraction positions for extraction (YES), the process proceeds to step ST19, and if it is determined that there are no detection results and extraction positions for extraction (NO), the process proceeds to step ST18. An example of the process in step ST16 (second process Pb) will be described in detail later with reference to FIG. 6.

In step ST18, it is determined whether extraction of the workpieces in the container has been completed, and if it is determined that extraction of the workpieces in the container has been completed (YES), the process ends. Conversely, if it is determined in step ST18 that extraction of the workpieces in the container has not been completed (NO), the process returns to step ST11, where the 3D sensor measures the plurality of workpieces in the container, and the above-mentioned process is repeated.

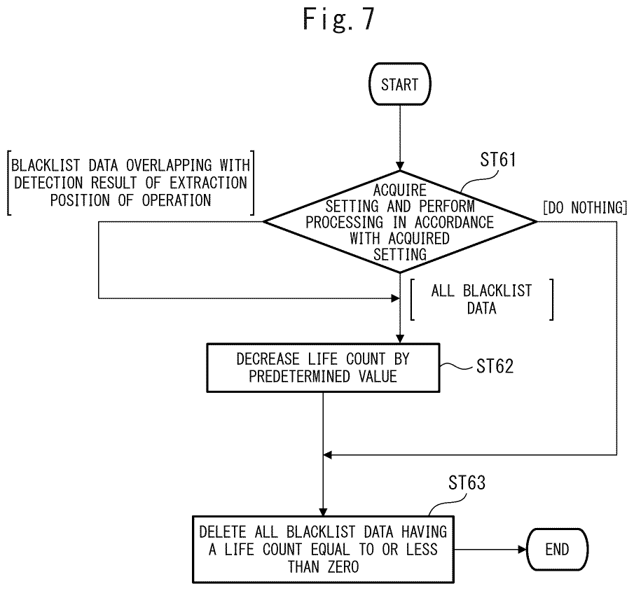

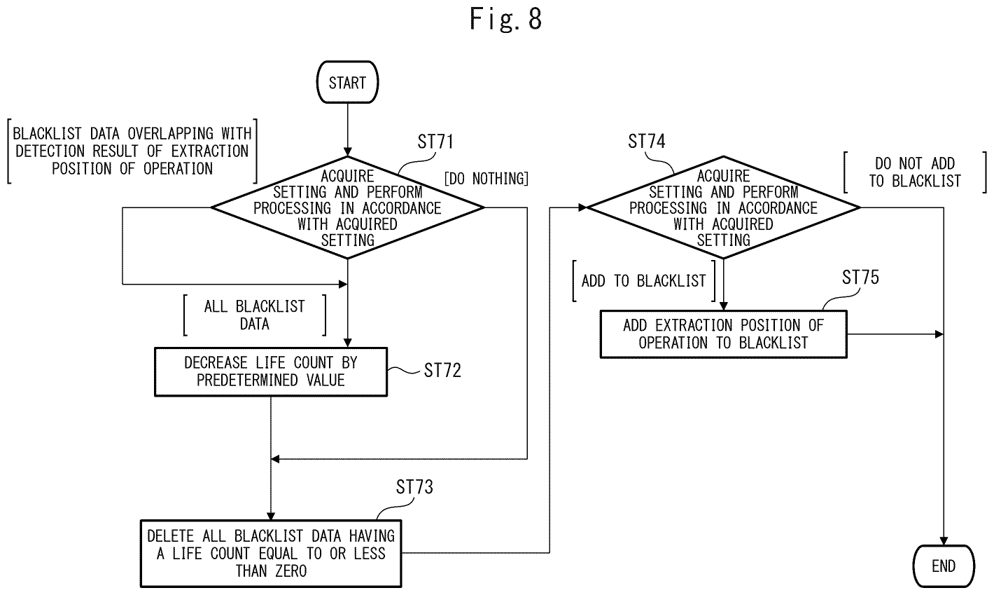

In step ST19, the detection results and the extraction position for extraction are determined, and the process proceeds to step ST20, where operations such as extraction, shifting, and collapsing are performed, and the process proceeds to step ST21. In step ST21, it is determined whether the operation was successful, and if it is determined that the operation was successful (YES), the process proceeds to step ST22 (third process Pc), and if it is determined that the operation was not successful (NO), the process proceeds to step ST23 (fourth process Pd). An example of the process of step ST22 (third process Pc) will be described in detail later with reference to FIG. 7, and an example of the process of step ST23 (fourth process Pd) will be described in detail later with reference to FIG. 8.

FIG. 5 is a flowchart explaining an example of the first process Pa (the process of steps ST14 and ST15) in the flowchart depicted in FIG. 4. This first process Pa relates to, for example, blacklist processing for other workpieces moved by the extraction operation performed by the industrial robot 1 on a workpiece in a container.

As depicted in FIG. 5, when the first process Pa starts (after the calculation of the extraction position for each workpiece in step ST13), it is determined in step ST31 whether there is a new unconfirmed detection result.

If it is determined in step ST31 that there are no new unconfirmed detection results (NO), the process proceeds to step ST34, where all blacklisted data with the deletion flag set is deleted from the blacklist, and the first process Pa ends. The case where it is determined as NO in step ST31 corresponds to, for example, the case where the process from step ST32 onwards has been performed on the extraction positions of all detection results and all blacklisted data. Once all blacklisted data with the deletion flag set has been deleted from the blacklist in step ST34, the process proceeds to step ST16 (second process Pb) of FIG. 4.

Conversely, if it is determined in step ST31 that there is a new unconfirmed detection result (YES), the process proceeds to step ST32, where the position and orientation and the extraction position of the detection result are acquired, and the process proceeds to step ST33. In step ST33, it is determined whether there is unconfirmed data in the blacklist, and if it is determined that there is unconfirmed data in the blacklist (YES), the process proceeds to step ST35, and if it is determined that there is no unconfirmed data in the blacklist (NO), the process returns to step ST31.

In step ST35, the blacklist data is acquired, and the process proceeds to step ST36 to compare the detection result with the position and orientation of the blacklist data, and then to step ST37 to determine whether or not there is overlap. The position and orientation (X, Y, Z, W, P, R) of the blacklist data described above may be, for example, only the position (X, Y, Z) of the blacklist data.

If it is determined in step ST37 that the position and orientation of the detection result overlaps with that of the blacklist data (YES), the process proceeds to step ST38, and if it is determined that they do not overlap (NO), the process returns to step ST33. In step ST38, a deletion flag is set for the blacklist data, and the process proceeds to step ST39 to compare the position and orientation of the extraction position of the blacklist data with that of the detection result. As described above, the comparison of the position and orientation data (X, Y, Z, W, P, R) may be performed by comparing only the position data (X, Y, Z). Moreover, the orientation data (W, P, R) is merely one representation format, and may be another representation format such as a rotation matrix, a quaternion, a rotation axis and a rotation angle, or polar coordinates. It should be noted that the position and orientation data (X, Y, Z, W, P, R) may be compared using only the position data (X, Y, Z) or only (X, Y), as in other processes described below, which makes it possible to lower the number of parameters to be compared. This is because, for example, when measuring a workpiece in a container from above using a three-dimensional sensor (X, Y, Z), since it is not possible to measure a workpiece hidden under a workpiece visible from above using the three-dimensional sensor, it is possible to use the output of a two-dimensional sensor (X, Y) to take overlaps into account.

The process proceeds to step ST40 to determine whether or not there is a duplication (comparison determination), and if it is determined that there is a duplication (YES), the process proceeds to step ST41, and if it is determined that there is no duplication (NO), the process returns to step ST33. In step ST41, the extraction position of the detection result is added to the blacklist, and data other than the workpiece ID, extraction position ID, detection position, extraction position, and deletion flag of the compared blacklist data is copied, and the process returns to step ST33.

Specifically, when the information of a newly detected extraction position (position and orientation of the detection result) based on data from the sensor overlaps with the information (position and orientation) of an extraction position already stored in the blacklist, the newly detected extraction position is stored in the blacklist. Furthermore, data other than the workpiece ID, extraction position ID, detection position, extraction position, and deletion flag of the compared extraction position stored in the blacklist is copied (inherited). The information of the overlapping extraction position stored in the blacklist is deleted. When the newly detected extraction position spatially overlaps with an extraction position already stored in the blacklist (position data (X, Y, Z) overlaps within a predetermined error range (threshold)), the information of the overlapping extraction position stored in the blacklist may be inherited.

FIG. 5 is a view explaining an example of the first process Pa, and various settings are possible for, for example, the error range (margin; threshold) when determining overlap, and the range that is considered to be close to and influenced by the extraction position added to the blacklist, etc. It should be noted that when the extraction of a workpiece is successful, a process in which all extraction positions set for that workpiece are deleted from the list for extraction and the blacklist is naturally performed.

FIG. 6 is a flowchart explaining an example of the second process Pb in the flowchart depicted in FIG. 4. As depicted in FIG. 6, when the second process Pb in the flowchart of FIG. 4 starts, in step ST51, it is determined whether there is non-updated data in the blacklist. If it is determined in step ST51 that there is non-updated data in the blacklist (YES), the process proceeds to step ST52, and if it is determined that there is no non-updated data in the blacklist (NO), the second process Pb ends. When the second process Pb ends, the process proceeds to step ST17 of the flowchart of FIG. 4 described above.

In step ST52, the life count of the blacklisted data is decreased by a predetermined value (for example, by “1”), and the process proceeds to step ST53, where the visit count of the blacklisted data is increased by a predetermined value (for example, by “1”). For example, the life count may be set to “10” as an initial value (when stored in the blacklist), and the visit count may be set to “1” as an initial value.

The process proceeds to step ST54 and it is determined whether the life count is ≤0. The reason for determining whether the life count is ≤0 is that, for example, if the determined value to be decreased in step ST52 is set to “3”, and the previous life count was “1”, it may become negative.

The value by which the life count is decreased in step ST52 may not be a uniform fixed value, but may be weighted in accordance with the distance from the extraction position accessed to perform the extraction operation. For example, the life count may be decreased by “3” for an extraction position close to the accessed extraction position, and may be decreased by “1” for an extraction position at a certain distance from the accessed extraction position. In this manner, the weight is set for the value by which the life count set for the first extraction position is decreased based on the distance from the second extraction position related to (and resulting in failure of) the object extraction operation. Specifically, the weight may be set for the value by which the life count set for the extraction position is decreased based on a predetermined condition (third condition).

This is because a workpiece with an extraction position set very close (for example, within a few mm) to the accessed extraction position is more likely to move than a workpiece that is a certain distance away (for example, about a few cm), so it is preferable to decrease the life count by a large amount. Furthermore, it is also possible to weight the value by which the life count is decreased depending on the type of access to the workpiece, such as whether the access is an extraction operation itself, or a shifting or collapsing operation. For example, if the access to the workpiece is a collapsing operation, the value by which the life count is decreased is set to a large value, and if the access to the workpiece is an extraction operation or a shifting operation, the value by which the life count is decreased is set to a small value.

If it is determined in step ST54 that the life count is ≤0 (YES), the process proceeds to step ST56, and if it is determined that the life count is not ≤0 (NO), the process proceeds to step ST55. In step ST55, it is determined whether the visit count is ≥ a predetermined value (for example, “5”). If it is determined in step ST55 that the visit count is ≥ the predetermined value (YES), the process proceeds to step ST56, and if it is determined that the visit count is not ≥ the predetermined value (NO), the process returns to step ST51 and the same process is repeated.

In this manner, a visit count is set for the first extraction position of the workpiece stored in the blacklist, and when the first extraction position is included within a predetermined range (surrounding) from the second extraction position related to (failed in) the extraction operation of the object, the visit count of the first extraction position is increased. When the visit count of the first extraction position becomes a predetermined value (for example, “5”) or more, the first extraction position is deleted from the blacklist. Specifically, a visit count is set for the extraction position of the object stored in the blacklist, and the visit count set for the extraction position is increased based on a predetermined condition (first condition). When the visit count set for the extraction position becomes a predetermined value or more, the extraction position of the object stored in the blacklist is deleted from the blacklist. As a result, the first extraction position becomes a target for access as an extraction position not stored in the blacklist.

Furthermore, a life count is set for the first extraction position of the workpieces stored in the blacklist, and the life count of the first extraction position is decreased based on the number of times an extraction operation of an arbitrary workpiece has been performed. When the life count of the first extraction position becomes zero or less, the first extraction position is deleted from the blacklist. Specifically, a life count is set for the extraction position of the object stored in the blacklist, and the life count set for the extraction position is decreased based on a predetermined condition (second condition). When the life count set for the extraction position becomes zero or less, the extraction position of the object stored in the blacklist is deleted from the blacklist. As a result, the first extraction position becomes an object of access as an extraction position not stored in the blacklist. It should be noted that the initial values of the life count and the visit count, the value to be decreased/increased, etc., may be changed and modified in various manners in accordance with the specifications and requirements of the machine system to which the present embodiment is applied.

FIG. 7 is a flowchart explaining an example of the third process Pc in the flowchart depicted in FIG. 4. As depicted in FIG. 7, when the third process Pc in the flowchart of FIG. 4 starts, in step ST61, a setting (predetermined setting) is acquired, and processing is performed in accordance with the acquired setting. In step ST61, if it is determined that blacklist data overlapping with the detection result of the extraction position of the operation has been set (leftward), and all blacklist data has been set (downward), the process proceeds to step ST62. It should be noted that in step ST61, if it is determined that nothing is to be done (rightward), the process proceeds directly to step ST63.

In step ST62, the life count is decreased by a predetermined value, and the process proceeds to step ST63. The initial value of the life count and the value by which the life count is decreased may be changed or modified in various manners in accordance with the specifications and requirements of the mechanical system to which the present embodiment is applied. In step ST63, all blacklist data having a life count which is equal to or less than zero is deleted, and the third process Pc ends. After the third process Pc ends, the process proceeds to step ST17 in the flowchart of FIG. 4 described above.

FIG. 8 is a flowchart explaining an example of the fourth process Pd in the flowchart depicted in FIG. 4. As depicted in FIG. 8, when the fourth process Pd in the flowchart of FIG. 4 starts, in step ST71, a setting is acquired, and processing is performed in accordance with the acquired setting. In step ST71, if it is determined that blacklist data overlapping with the detection result of the extraction position of the operation has been set (leftward), and that all blacklist data has been set (downward), the process proceeds to step ST72. It should be noted that in step ST71, if it is determined that nothing is to be done (rightward), the process proceeds directly to step ST73.

In step ST72, the life count is decreased by a predetermined value, and the process proceeds to step ST73. As described above, the initial value of the life count and the value by which the life count is decreased may be changed or modified in various manners in accordance with the specifications and requirements of the mechanical system to which the present embodiment is applied. In step ST73, all data in the blacklist having a life count of zero or less is deleted, and the process proceeds to step ST74, where a setting is obtained and processing is performed in accordance with the obtained setting.

If it is determined in step ST74 that the operation should be added to the blacklist (downward), the process proceeds to step ST75, where the extraction position of the operation is added to the blacklist and the fourth process Pd ends, whereas if it is determined that the operation should not be added to the blacklist (rightward), the fourth process Pd ends. Specifically, if it is determined in step ST74 that the operation should not be added to the blacklist and the process of step ST75 ends, the process proceeds to step ST17 in the flowchart of FIG. 4.

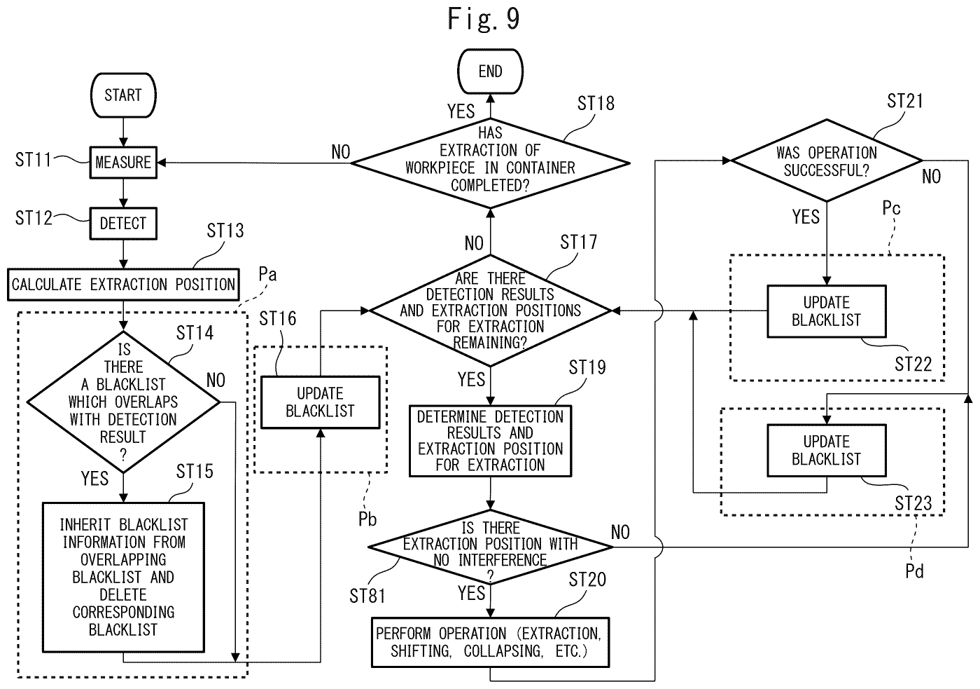

FIG. 9 is a flowchart explaining an example of the processing of a first modified extraction machine control program according to the present embodiment. As is clear from a comparison of FIG. 9 with FIG. 4 described above, the processing of the first modified extraction machine control program according to the present embodiment adds a new step ST81 between steps ST19 and ST20 of the first example. The other steps ST11 to ST23 are the same as those described with reference to FIG. 4, and description thereof has been omitted.

As depicted in FIG. 9, the processing of the first modification example of the extraction machine control program according to the present embodiment starts, and proceeds to step ST19. When the detection results and extraction position for extraction are determined, the process proceeds to step ST81. In step ST81, it is determined whether there is an extraction position that does not interfere. Specifically, in step ST81, it is determined, for example, whether there is an extraction position where the hand unit 12 of the industrial robot 1 does not interfere with the side surface of the container 4, and if it is determined that there are no extraction positions which do not interfere (NO), the process proceeds to step ST23. Conversely, if it is determined that there is an extraction position that does not interfere (YES) in step ST81, the process proceeds to step ST20, where operations such as extraction, shifting, and collapsing are performed.

The process of step ST81 includes a determination process for determining whether the extraction position may not be reached when the robot is outside its operating range or when a singular point of the robot is on the movement path to the extraction position, in addition to interference with peripheral devices or other workpieces. In such a case, the corresponding extraction position may be added to the blacklist. Specifically, for example, a workpiece related to automatic path generation may also be added to the blacklist. It should be noted that automatic path generation is a function in which, for example, the robot controller calculates a path along which the robot may move from the current position to the extraction position (a path that avoids interference between the robot and peripheral devices or workpieces, outside the operating range of the robot, singular points of the robot, etc.), and the robot extracts the workpiece through the calculated path. Furthermore, it is preferable to add the extraction position to the blacklist when the automatic path generation function gives a result that, for example, there are no available paths. It should be noted that the extraction positions to be added to the blacklist described above may be some or all of the plurality of extraction positions that satisfy the conditions.

Thus, the first modification example of the extraction machine control program according to the present embodiment takes into consideration whether there is an extraction position where the hand unit 12 of the industrial robot 1 does not interfere with the side surface of the container 4, in addition to the first example described with reference to FIG. 4. The details of the first process Pa, the second process Pb, the third process Pc, and the fourth process Pd of FIG. 9 are the same as those described with reference to FIG. 5 to FIG. 8, and may be adopted as-is in the extraction machine control program of the present first modification example.

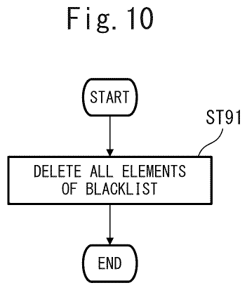

FIG. 10 is a flowchart explaining the main processing steps in a second modification example of the extraction machine control program according to the present embodiment, and is for explaining another example of the second process Pb in the flowchart depicted in FIG. 4 described above.

As depicted in FIG. 10, when the second process Pb in the flowchart of FIG. 4 starts, in step ST91, all elements of the blacklist are deleted, and the second process Pb ends. Thus, according to this second modification example, if there are no new detection results that overlap with the data stored in the blacklist, all data in the blacklist is deleted. Specifically, if there are no new detection results after measurement that overlap with the blacklist, this indicates that no data is present in the position and orientation when stored in the blacklist due to reasons such as a collapse of the load or the extraction of a workpiece. Therefore, in such a case, it is preferable to delete all data in the blacklist, which makes it possible to extract objects more efficiently.

The second modification example depicted in FIG. 10 may be adopted as the second process Pb not only in the extraction machine control program of the first example described with reference to FIG. 4 to FIG. 8 but also in the extraction machine control program of the first modification example described with reference to FIG. 9. The first modification example depicted in FIG. 9, i.e., the modification example in which the process of step ST81 is added between steps ST19 and ST20, may also be applied to the extraction machine control programs of the second and third examples, which are described later. Furthermore, the second modification example depicted in FIG. 10, i.e., the process of deleting all elements of the blacklist in step ST91 as the second process Pb, may also be applied to the extraction machine control program of the second example, which is described later. Specifically, as the second process Pb′ in the extraction machine control program of the second example described later, the priority of the data of all extraction positions in the extraction position list may be returned to a predetermined value (for example, an initial value).

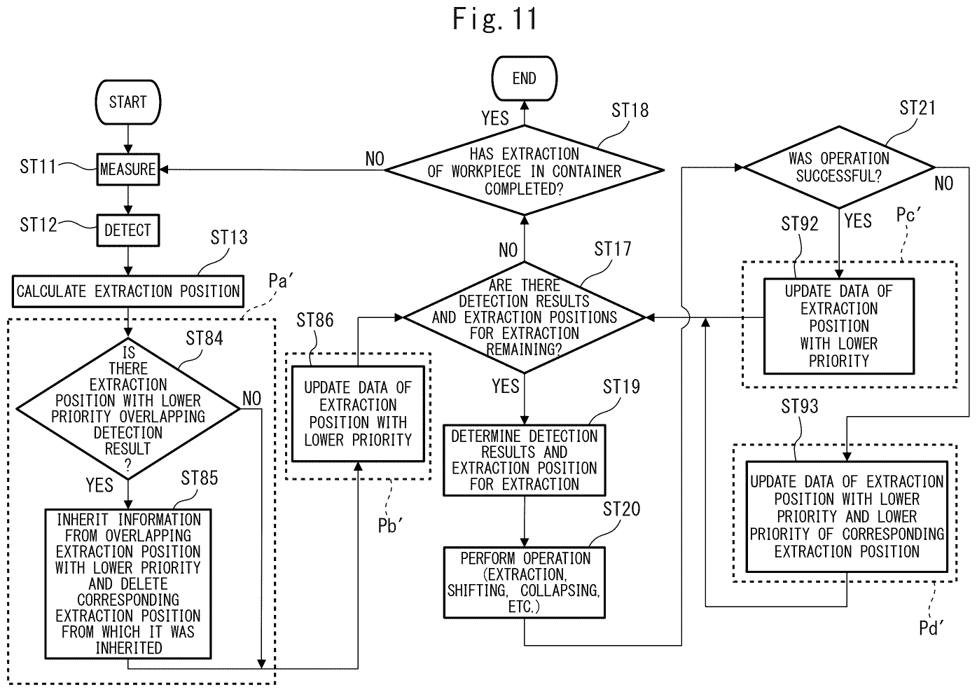

Next, a second example of the extraction machine control program according to the present embodiment will be described in detail with reference to FIG. 11 to FIG. 16. In the machine control program of the first example according to the present embodiment described above, the blacklist 23 is used for alternative control, such as whether or not an extraction position is to be the target of extraction of the workpiece W by the robot 1, based on whether or not the extraction position is stored. In contrast, in the machine control program of the second example according to the present embodiment, instead of alternative control using the blacklist 23, an extraction priority (weight) is set for each extraction position, and the order of the extraction positions to be the target of extraction of the workpiece W by the robot 1 is controlled based on priority.

Specifically, the list 23 of FIG. 2 described above is used, for example, as an extraction position list to which a new priority item has been added. The life count and visit count processing described above is performed in the same manner as in the first example described above. However, for example, when the life count of an extraction position becomes zero or less, rather than deleting (erasing) the data in the blacklist 23 and processing the extraction position as an accessible extraction position that is not stored in the blacklist 23, the priority of the data of the extraction position the life count of which becomes zero or less is returned to a predetermined value (for example, the initial value “100”) and the extraction position is processed as an accessible extraction position.

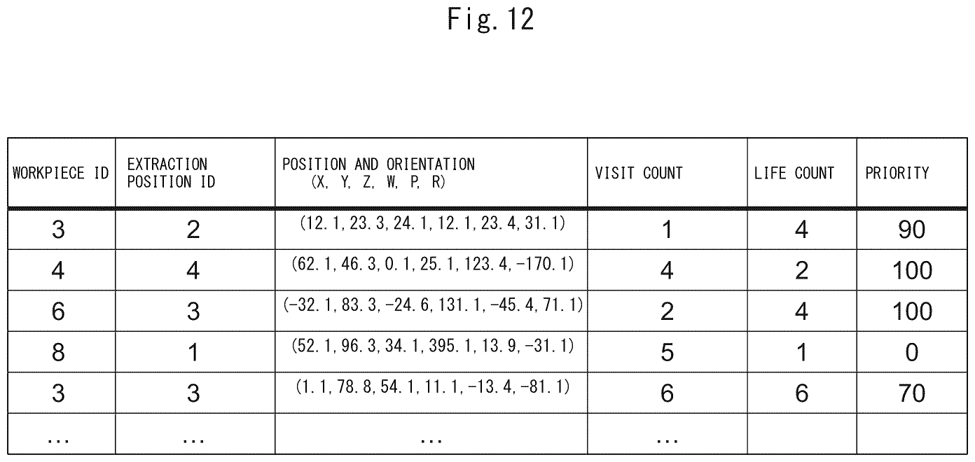

FIG. 11 is a flowchart explaining an example of processing in a second example of the extraction machine control program according to the present embodiment, and FIG. 12 is a view depicting an example of a list (extraction position list) in the industrial robot system depicted in FIG. 2. The processing of steps ST11 to ST13 and ST18 to ST21 of FIG. 11 is substantially the same as that described with reference to FIG. 4, and thus, the detailed description of those processes has been omitted. As is clear from a comparison of FIG. 12 with FIG. 3 described above, the extraction position list used in the extraction machine control program of this second example corresponds to the blacklist of FIG. 4 to which a priority item, for example, indicated by a value of “0” to “100”, has been added. Priority is an index for selecting each extraction position from the extraction position list 23, and as long as it is possible to identify the order of priority, it is not limited to integers or real numbers, and may be various symbols, etc., as long as a magnitude relationship may be defined.

As depicted in FIG. 11, an example of an extraction machine control program of the second example starts, and in step ST13, the extraction position of each workpiece is calculated from the position and orientation (x, y, z, w, p, r) of each workpiece detected in step ST12, and the program then proceeds to step ST84. In step ST13, if a plurality of extraction positions may be set for one workpiece due to the shape and size of the workpiece W, these plurality of extraction positions are calculated. Furthermore, it is not necessary to calculate two or more extraction positions for each of all the workpieces in the container in step ST13, and for example, a workpiece with only one extraction position set may be included.

In step ST84, it is determined (comparison determination) whether or not there is an extraction position with a lower priority that overlaps with the detection result, and if it is determined that there is an extraction position with a lower priority that overlaps with the detection result (YES), the process proceeds to step ST85. In step ST85, information is inherited from the overlapping extraction position with a lower priority, the corresponding extraction position from which it was inherited is deleted, and the process proceeds to step ST86 (second process Pb′).

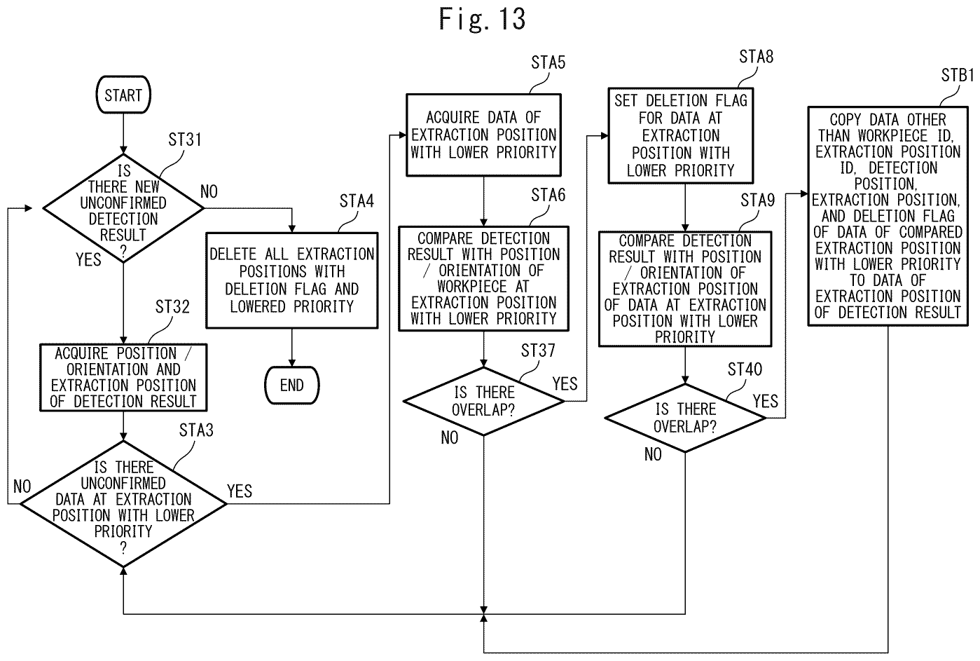

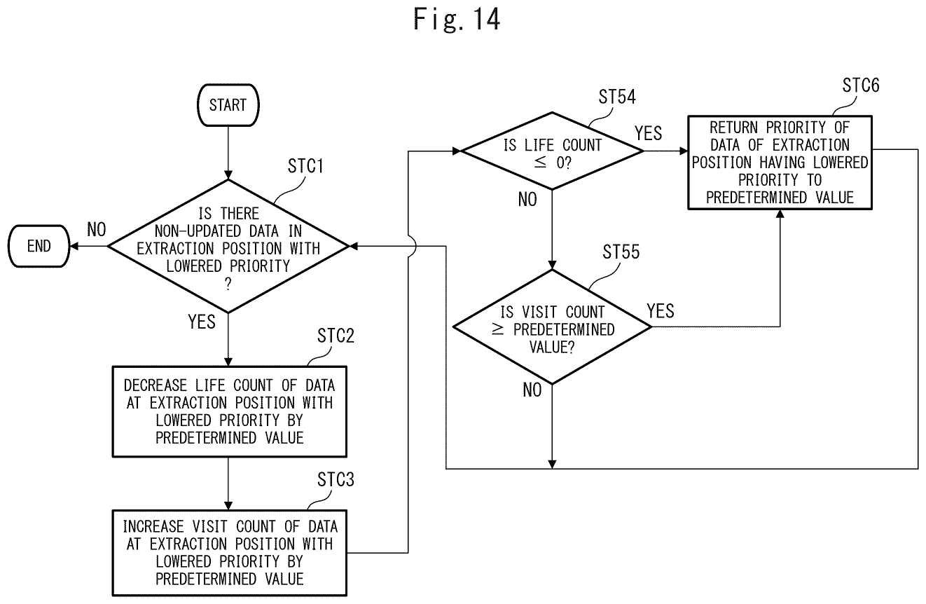

Conversely, if it is determined in step ST84 that there are no extraction positions with a lower priority that overlap with the detection result (NO), the process proceeds directly to step ST86. Steps ST84 and ST85 constitute a first process Pa′. An example of the first process Pa′ will be described later in detail with reference to FIG. 13. In step ST86, the data of the extraction position with a lower priority is updated, and the process proceeds to step ST17 to determine whether or not there are any detection results and extraction positions for extraction. An example of the process of step ST86 (second process Pb′) will be described later in detail with reference to FIG. 14.

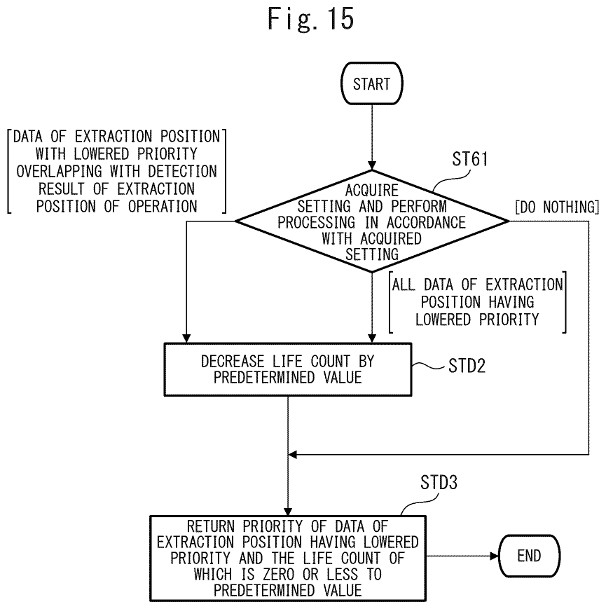

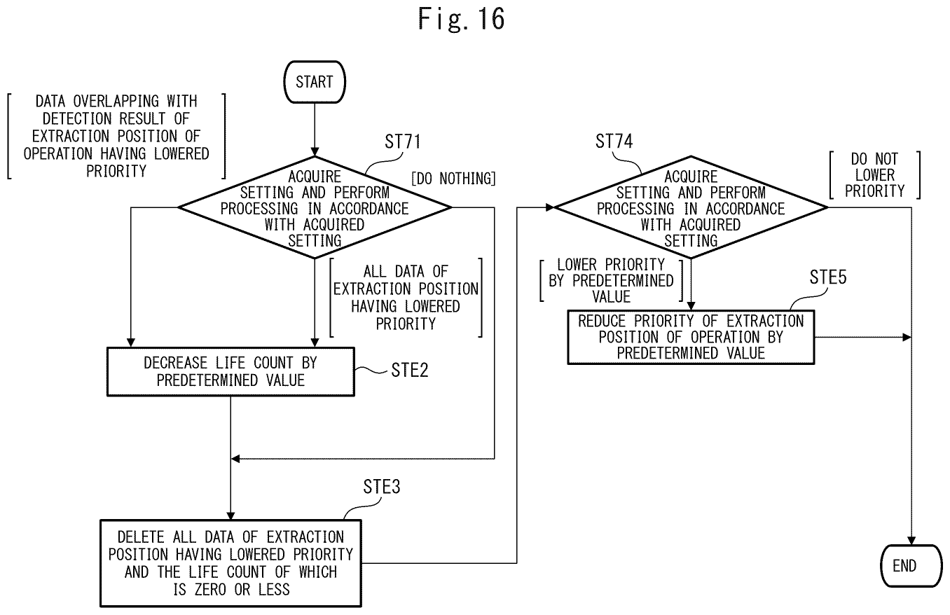

In step ST21, it is determined whether the operation has been successful, and if it is determined that the operation has been successful (YES), the process proceeds to step ST92 (third process Pc′), and if it is determined that the operation has not been successful (NO), the process proceeds to step ST93 (fourth process Pd′). It should be noted that an example of the process of step ST92 (third process Pc′) will be described in detail later with reference to FIG. 15, and an example of the process of step ST93 (fourth process Pd′) will be described in detail later with reference to FIG. 16.

FIG. 13 is a flowchart explaining an example of the first process Pa′ (the process of steps ST84 and ST85) in the flowchart depicted in FIG. 11. As depicted in FIG. 13, when the first process Pa′ starts (after the calculation of the extraction position for each workpiece in step ST13), in step ST31, it is determined whether there is a new unconfirmed detection result. If it is determined in step ST31 that there are no new unconfirmed detection results (NO), the process proceeds to step STA4, where all extraction positions with a deletion flag and a lowered priority are deleted, and the first process Pa′ ends. In this case, in step STA4, once all extraction positions with a deletion flag and a lowered priority are deleted, the process proceeds to step ST86 (second process Pb′) in FIG. 11.

Conversely, if it is determined in step ST31 that there is a new unconfirmed detection result (YES), the process proceeds to step ST32, where the position and orientation of the detection result and the extraction position are acquired, and the process proceeds to step STA3. In step STA3, it is determined whether there is unconfirmed data at an extraction position with a lower priority, and if it is determined that there is unconfirmed data at an extraction position with a lower priority (YES), the process proceeds to step STA5, and if it is determined that there is no unconfirmed data at an extraction position with a lower priority (NO), the process returns to step ST31.

In step STA5, data of the extraction position with lower priority is acquired, and the process proceeds to step STA6, where the detection result is compared with the position and orientation of the workpiece at the extraction position with lower priority, and the process proceeds to step ST37, where it is determined whether or not there is overlap. The position and orientation (X, Y, Z, W, P, R) of the workpiece at the extraction position with lower priority described above may be, for example, only the position (X, Y, Z) of the workpiece at the extraction position with lower priority, as explained with reference to FIG. 5.

If it is determined in step ST37 that the detection result and the position and orientation of the workpiece at the extraction position with a lower priority overlap (YES), the process proceeds to step STA8, and if it is determined that they do not overlap (NO), the process returns to step STA3. In step STA8, a deletion flag is set for the data at the extraction position with a lower priority, and the process proceeds to step STA9 to compare the detection result with the position and orientation of the extraction position of the data at the extraction position with a lower priority.

As described above, the comparison of the position and orientation data (X, Y, Z, W, P, R) may be performed by comparing only the position data (X, Y, Z). Furthermore, the orientation data (W, P, R) is merely one representation format, and may be other representation formats such as a rotation matrix, a quaternion, a rotation axis and a rotation angle, or polar coordinates. As described above, the comparison of the position and orientation data (X, Y, Z, W, P, R) may be performed by comparing only the position data (X, Y, Z) or only the position data (X, Y), which makes it possible to lower the number of parameters to be compared.

The process proceeds to step ST40 to determine whether there is an overlap, and if it is determined that there is an overlap (YES), the process proceeds to step STB1, and if it is determined that there is no overlap (NO), the process returns to step STA3. In step STB1, data other than the workpiece ID, extraction position ID, detection position, extraction position, and deletion flag of the data of the extraction position with a lower priority compared is copied to the data of the extraction position of the detection result, and the process returns to step STA3.

FIG. 14 is a flowchart explaining an example of the second process Pb′ in the flowchart depicted in FIG. 11. As depicted in FIG. 14, when the second process Pb′ in the flowchart of FIG. 11 starts, in step STC1, it is determined whether or not there is non-updated data in the extraction position with a lowered priority. In step STC1, if it is determined that there is non-updated data in the extraction position with a lowered priority (YES), the process proceeds to step STC2, and if it is determined that there is no non-updated data in the extraction position with a lowered priority (NO), the second process Pb′ ends. When the second process Pb′ ends, the process proceeds to step ST17 in the flowchart of FIG. 11 described above.

In step STC2, the life count of the data at the extraction position with the lowered priority is decreased by a predetermined value (for example, by “1”), and the process then proceeds to step STC3, where the visit count of the data at the extraction position with the lowered priority is increased by a predetermined value (for example, by “1”). For example, the life count may be set to “10” as an initial value, and the visit count may be set to “1” as an initial value. The process then proceeds to step ST54, where it is determined whether the life count is ≤0.

The value by which the life count is decreased in step STC2 may not be a uniform fixed value, but may be weighted in accordance with the distance from the extraction position accessed to perform the extraction action. For example, the life count may be decreased by “3” for an extraction position close to the accessed extraction position, and may be decreased by “1” for an extraction position at a certain distance from the accessed extraction position. In this manner, a weight is set for the value by which the life count set for the first extraction position is decreased based on the distance from the second extraction position related to the object extraction operation. In other words, a weight may be set for the value by which the life count set for the extraction position is decreased based on a predetermined condition (third condition).

This is because a workpiece with an extraction position set very close (e.g., within a few mm) to the accessed extraction position is more likely to move than a workpiece that is some distance away (e.g., about a few cm), and thus, it is preferable to decrease the life count by a large amount. Furthermore, it is also possible to weight the value by which the life count is decreased in accordance with the type of access to the workpiece, such as whether the access is an extraction operation itself, or a shifting or collapsing operation. For example, if the access to the workpiece is a collapsing operation, the value by which the life count is decreased is set to a large value, and if the access to the workpiece is an extraction operation or a shifting operation, the value by which the life count is decreased is set to a small value.

If it is determined in step ST54 that the life count is ≤0 (YES), the process proceeds to step STC6, where the priority of the data at the extraction position with the lowered priority is returned to a predetermined value (for example, the initial value “100”). Conversely, if it is determined in step ST54 that the life count is not ≤0 (NO), the process proceeds to step ST55, where it is determined whether the visit count is ≥ a predetermined value (for example, “5”). If it is determined in step ST55 that the visit count is ≥ the predetermined value (YES), the process proceeds to step STC6, where the priority of the data at the extraction position with the lowered priority is returned to a predetermined value (for example, the initial value). Conversely, if it is determined in step ST55 that the visit count is not ≥ the predetermined value (NO), the process returns to step STC1, where the same process is repeated.

In this manner, a visit count is set for the first extraction position of the workpiece having a lowered priority, and when the first extraction position is included within a predetermined range from the second extraction position related to the extraction operation of the object, the visit count of the first extraction position is increased. When the visit count of the first extraction position becomes a predetermined value (for example, “5”) or more, the priority of the data of the first extraction position of the workpiece having a lowered priority is returned to a predetermined value. Specifically, a visit count is set for the extraction position of the workpiece having a lowered priority, and the visit count set for the extraction position is increased based on a predetermined condition (first condition). When the visit count set for the extraction position becomes a predetermined value or more, the priority of the data of the extraction position of the workpiece having a lowered priority is returned to a predetermined value. As a result, the first extraction position becomes an object of access as an extraction position of a workpiece with a higher priority.

Furthermore, a life count is set for the first extraction position of the workpiece having a lowered priority, and the life count of the first extraction position is decreased based on the number of times an extraction operation of an arbitrary workpiece has been performed. When the life count of the first extraction position becomes zero or less, the priority of the data of the extraction position of the workpiece having a lowered priority is returned to a predetermined value. Specifically, a life count is set for the extraction position of the workpiece having a lowered priority, and the life count set for the extraction position is decreased based on a predetermined condition (second condition). When the life count set for the extraction position becomes zero or less, the priority of the data of the extraction position of the workpiece having a lowered priority is returned to a predetermined value. As a result, the first extraction position becomes the target of access as the extraction position of a workpiece with a higher priority. It should be noted that the initial values of the visit count and life count, the values to decrease/increase, and the specified value for restoring the priority of the extraction position data of a workpiece having a lowered priority may be changed and modified in various manners in accordance with the specifications and requirements of the mechanical system to which the present embodiment is applied.

As described above, the second modification example described with reference to FIG. 10 may be adopted as the second process Pb′ in the flowchart of FIG. 11. Specifically, as the second process Pb′ in the flowchart of FIG. 11, if there is no new detection result that overlaps with the workpiece of the data of the extraction position with a lower priority, the data of the extraction position with a lower priority may be deleted. This is because, for example, if there is no new detection result after measurement that overlaps with the data of the extraction position with a lower priority, it indicates that the workpiece is no longer present in the position and orientation when the priority was lowered due to a collapse of the load or the workpiece being extracted.

FIG. 15 is a flowchart explaining an example of the third process Pc′ in the flowchart depicted in FIG. 11. As depicted in FIG. 15, when the third process Pc′ in the flowchart of FIG. 11 starts, in step ST61, a setting (predetermined setting) is acquired, and processing is performed in accordance with the acquired setting. In step ST61, if it is determined that the data of the extraction position with a lower priority that overlaps with the detection result of the extraction position of the operation is set (leftward), and the data of the extraction position of all workpieces with a lower priority is set (downward), the process proceeds to step STD2. In addition, if it is determined that nothing is to be done (rightward) in step ST61, the process proceeds directly to step STD3.

In step STD2, the life count is decreased by a predetermined value, and the process proceeds to step STD3. As described above, the initial value of the life count and the value by which the life count is decreased may be changed and modified in various manners in accordance with the specifications and requirements of the machine system to which the present embodiment is applied. In step STD3, the priority of the data of the extraction position of the workpiece the priority of which has been lowered and the life count of which is zero or less is returned to a predetermined value (for example, the initial value “100”), and the third process Pc′ ends. After the third process Pc′ ends, the process proceeds to step ST17 in the flowchart of FIG. 11 described above.

FIG. 16 is a flowchart explaining an example of the fourth process Pd′ in the flowchart depicted in FIG. 11. As depicted in FIG. 16, when the fourth process Pd′ in the flowchart in FIG. 11 starts, in step ST71, a setting is acquired, and processing is performed according to the acquired setting. In step ST71, if it is determined that the data of the extraction position with a lower priority that overlaps with the detection result of the extraction position of the operation is set (leftward), and the data of the extraction positions of all workpieces with a lower priority is set (downward), the process proceeds to step STE2. It should be noted that, in step ST71, if it is determined that nothing is to be done (rightward), the process proceeds directly to step STE3.

In step STE2, the life count is decreased by a predetermined value, and the process proceeds to step STE3. As described above, the initial value of the life count and the value by which the life count is decreased may be changed or modified in various manners in accordance with the specifications and requirements of the machine system to which the present embodiment is applied. In step STE3, the priority of the data of the extraction position of the workpiece having a priority which has been lowered and having a life count which is equal to or less than zero is returned to a predetermined value (for example, the initial value), and the process proceeds to step ST74, where the settings are obtained and processing is performed in accordance with the obtained settings.

If it is determined in step ST74 that the priority is to be lowered by a predetermined value (downward), the process proceeds to step STE5, where the priority of the extraction position of the operation is lowered by a predetermined value and the fourth process Pd′ ends, and if it is determined that the priority is not to be lowered (rightward), the fourth process Pd′ ends as-is. In other words, if it is determined in step ST74 that the priority is not to be lowered and the process of step STE5 ends, the process proceeds to step ST17 in the flowchart of FIG. 11 described above.

In this manner, according to the second example of the extraction machine control program described with reference to FIG. 11 to FIG. 16, a priority item is added to the blacklist of the first example, and the next extraction position to be accessed may be selected based on that priority.

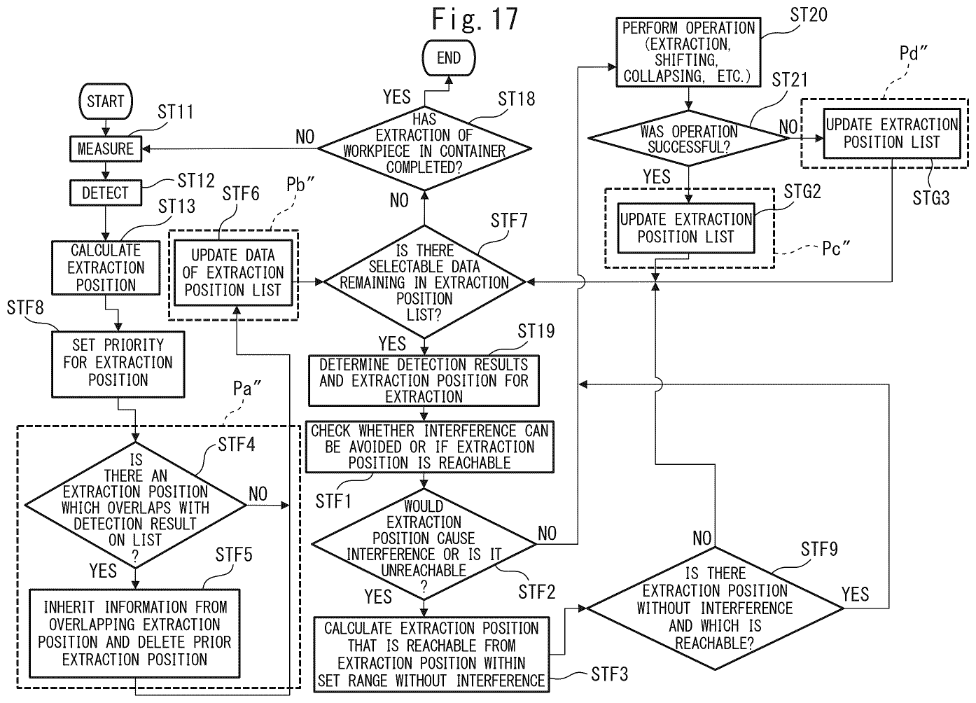

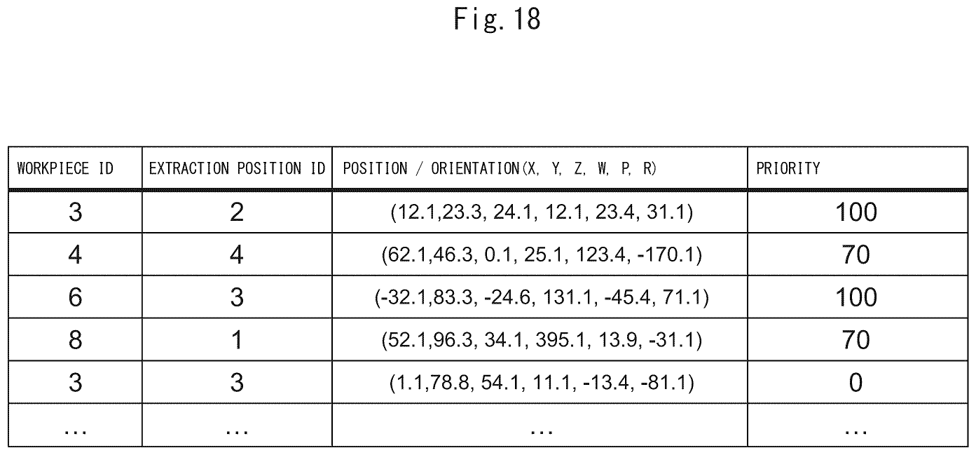

Hereinafter, a third example of the extraction machine control program according to the present embodiment will be described in detail with reference to FIG. 17 to FIG. 25. FIG. 17 is a flowchart explaining an example of processing in the third example of the extraction machine control program according to the present embodiment, and FIG. 18 is a view depicting another example of the list (extraction position list) in the industrial robot system depicted in FIG. 2. Since the processing in steps ST11 to ST13 and ST18 to ST21 of FIG. 17 is substantially the same as that explained with reference to FIG. 4, the detailed description of those processes has been omitted. As is clear from a comparison between FIG. 18 and FIG. 12 described above, the extraction position list 23 used in the extraction machine control program of the third example has deleted the items of visit count and life count of FIG. 12 and integrated them into the item of priority. Specifically, the data processing unit 22 integrates the processing of visit count and life count in the extraction machine control program of the second example into the processing of priority.

As depicted in FIG. 17, in step ST13, the extraction position of each workpiece is calculated from the position and orientation (x, y, z, w, p, r) of each workpiece detected in step ST12, and then in step STF8, a priority is set for the extraction position. The process then proceeds to step STF4 to determine whether or not there is an extraction position in the list that overlaps with the detection result.

In step ST13, if a plurality of extraction positions may be set for one workpiece due to the shape or size of the workpiece W, those plurality of extraction positions are calculated, and further, in step STF8, a priority is set for each extraction position. As described above, it is not necessary to calculate two or more extraction positions for each of the workpieces in the container in step ST13, and for example, it is possible to include a workpiece with only one extraction position set.

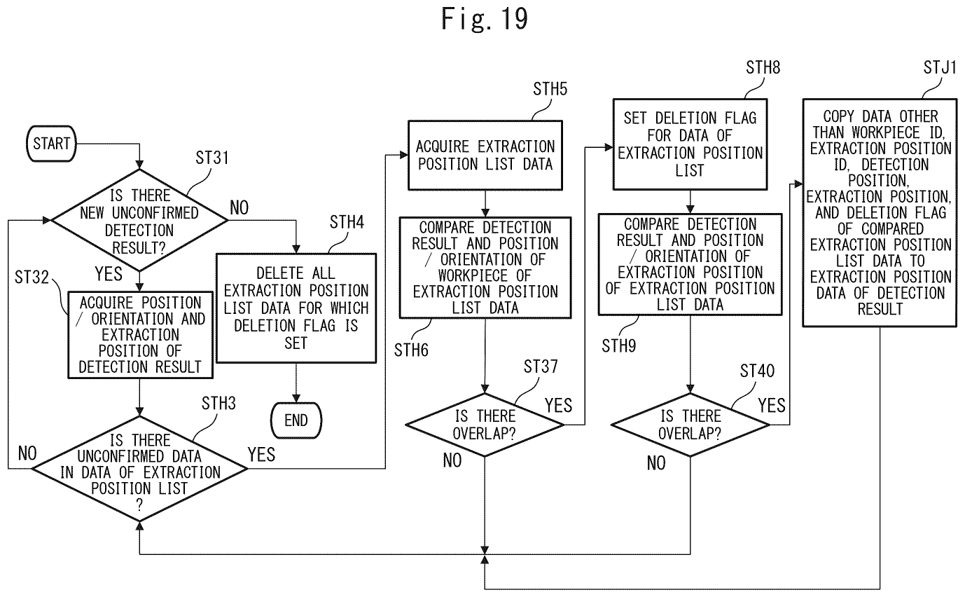

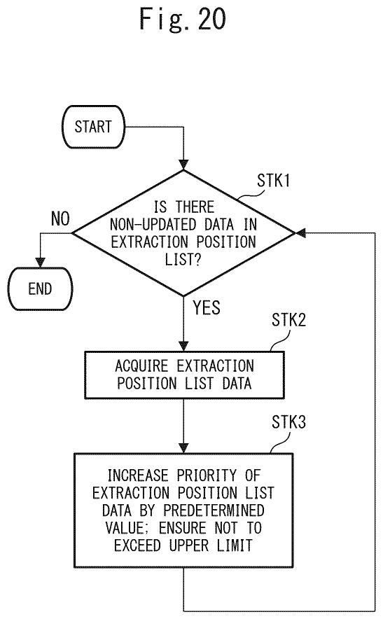

If it is determined in step STF4 that an extraction position that overlaps with the detection result is present in the list (YES), the process proceeds to step STF5, where information is inherited from the overlapping extraction position, the original extraction position is deleted, and the process then proceeds to step STF6. Conversely, if it is determined in step STF4 that an extraction position that overlaps with the detection result is not present in the list (NO), the process proceeds directly to step STF6 (second process Pb″). In step STF6, the data in the extraction position list is updated, and the process proceeds to step STF7, where it is determined whether selectable data remains in the extraction position list. Steps STF4 and STF5 constitute a first process Pa″. An example of the first process Pa″ will be described in detail later with reference to FIG. 19, and an example of a second process Pb″ will be described in detail later with reference to FIG. 20.

If it is determined in step STF7 that selectable data remains in the extraction position list (YES), the process proceeds to step ST19, and if it is determined that selectable data does not remain in the extraction position list (NO), the process proceeds to step ST18.

In step ST19, the extraction detection result and the extraction position are determined, and the process proceeds to step STF1 to check whether interference may be avoided or whether the extraction position may be reached. Checking whether interference may be avoided or whether the extraction position may be reached is performed by a process of recalculating whether the extraction position may be reached without interference within a tolerance range set for the attitude posture of the industrial robot for that extraction position and for the peripheral devices after the extraction position is calculated. The process then proceeds to step STF2 to determine whether interference will occur or the extraction position may not be reached.

If it is determined in step STF2 that there will be interference or that the extraction position is unreachable (YES), the process proceeds to step STF3, where an extraction position that is reachable from the extraction position within the set range without interference is calculated, and the process proceeds to step STF9. Conversely, if it is determined in step STF2 that there will be neither interference nor that the position is unreachable (NO), the process proceeds to step ST20, where operations such as extraction, shifting, and collapsing are performed, and the process then proceeds to step ST21. In step ST21, it is determined whether the operation was successful, and if it is determined that the operation was successful (YES), the process proceeds to step STG2 (third process Pc″), and if it is determined that the operation was unsuccessful (NO), the process proceeds to step STG3 (fourth process Pd″).

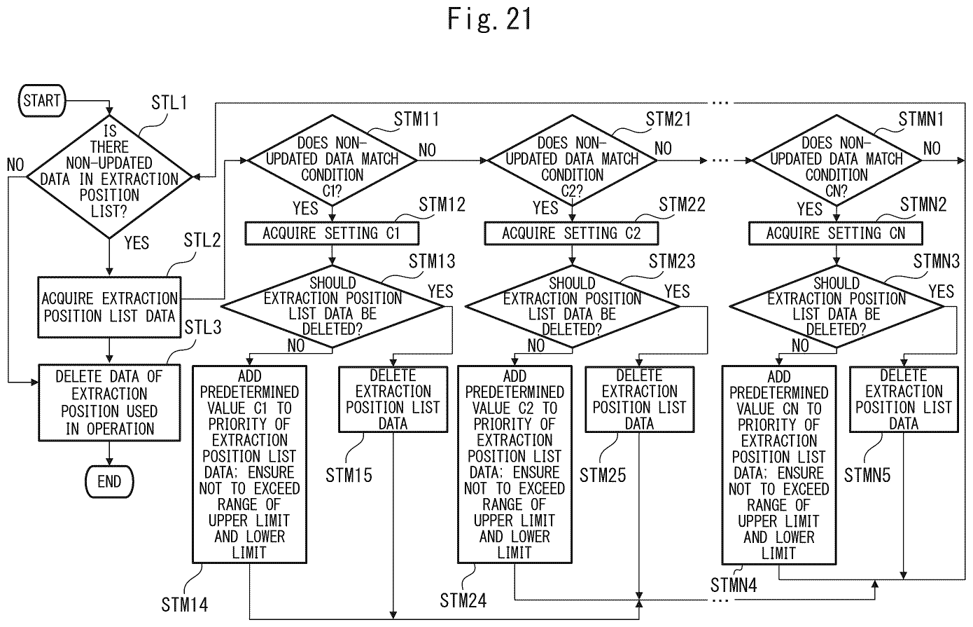

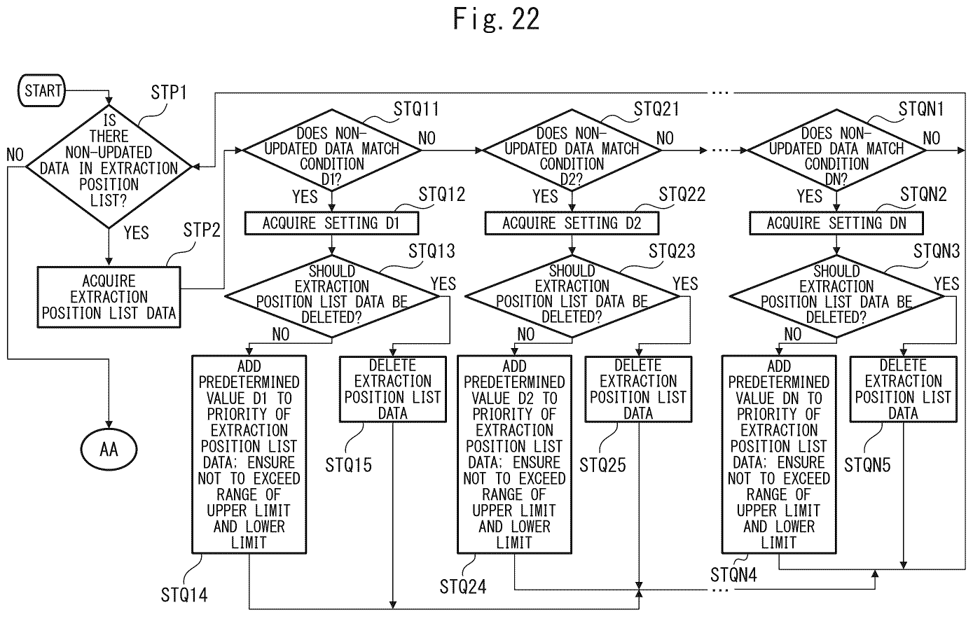

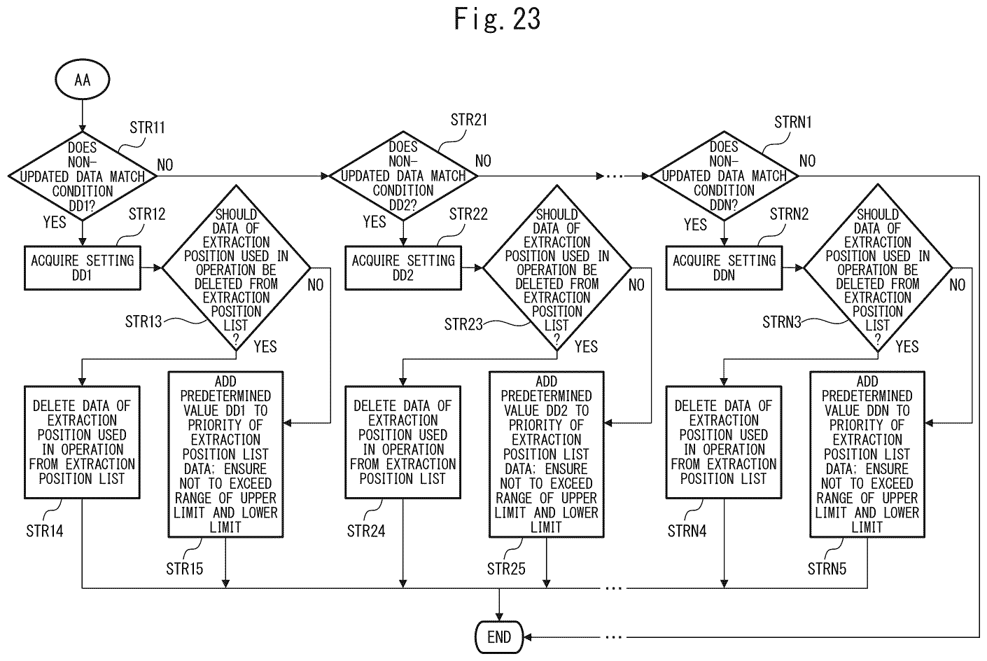

In step STF9, it is determined whether there is a reachable extraction position that does not interfere. If it is determined that there is a reachable extraction position (YES), the process proceeds to step ST20, and if it is determined that there are no reachable extraction positions (NO), the process proceeds to step STF7. An example of the process of step STG2 (third process Pc″) will be described in detail later with reference to FIG. 21, and an example of the process of step STG3 (fourth process Pd″) will be described in detail later with reference to FIG. 22 and FIG. 23.

FIG. 19 is a flowchart explaining an example of the first process Pa″ (the processing of steps STF4 and STF5) in the flowchart depicted in FIG. 17. As depicted in FIG. 19, when the first process Pa″ starts (after setting a priority for the extraction position in step STF8), it is determined in step ST31 whether there are any new unconfirmed detection results. If it is determined in step ST31 that there are no new unconfirmed detection results (NO), the process proceeds to step STH4, where all data in the extraction position list with the deletion flag set is deleted, and the first process Pa″ ends. Once all data in the extraction position list with the deletion flag set has been deleted in step STH4, the process proceeds to step STF6 (second process Pb″) of FIG. 17.

Conversely, if it is determined in step ST31 that there is a new unconfirmed detection result (YES), the process proceeds to step ST32, where the position and orientation of the detection result and the extraction position are acquired, and the process proceeds to step STH3. In step STH3, it is determined whether there is unconfirmed data in the data of the extraction position list, and if it is determined that there is unconfirmed data (YES), the process proceeds to step STH5, and if it is determined that there is no unconfirmed data (NO), the process returns to step ST31.

In step STH5, data of the extraction position list is obtained, and the process proceeds to step STH6, where the detection result is compared with the position and orientation of the workpiece of the data of the extraction position list, and further to step ST37, where it is determined whether or not there is overlap. It should be noted that the position and orientation (X, Y, Z, W, P, R) of the workpiece of the data of the extraction position list described above may be, for example, only the position (X, Y, Z) of the workpiece of the data of the extraction position, in the same manner as the first and second examples described above.

If it is determined in step ST37 that the detection result and the position and orientation of the workpiece in the data in the extraction position list overlap (YES), the process proceeds to step STH8, and if it is determined that they do not overlap (NO), the process returns to step STH3. In step STH8, a deletion flag is set for the data in the extraction position list, and the process proceeds to step STH9 to compare the detection result with the position and orientation of the extraction position in the data in the extraction position list, and then the process proceeds to step ST40.

In step ST40, it is determined whether there is an overlap, and if it is determined that there is an overlap (YES), the process proceeds to step STJ1, and if it is determined that there is no overlap (NO), the process returns to step STH3. In step STJ1, data other than the workpiece ID, extraction position ID, detection position, extraction position, and deletion flag of the data of the compared extraction position list is copied to the data of the extraction position of the detection result, and the process returns to step STH3.

FIG. 20 is a flowchart explaining an example of the second process Pb″ in the flowchart depicted in FIG. 17. As depicted in FIG. 20, when the second process Pb″ in the flowchart of FIG. 17 starts, in step STK1, it is determined whether or not there is non-updated data in the extraction position list. If it is determined in step STK1 that there is non-updated data in the extraction position list (YES), the process proceeds to step STK2, where the data in the extraction position list is obtained, and the process proceeds to step STK3. Conversely, if it is determined in step STK1 that there is no non-updated data in the extraction position list (NO), the second process Pb″ ends. When the second process Pb″ ends, the process proceeds to step STF7 in the flowchart of FIG. 17 described above.

In step STK3, the priority of the data in the extraction position list is increased by a determined value, but does not exceed the upper limit. Specifically, in step STK3, if there is non-updated data in the extraction position list, the priority of that data is increased by a predetermined value (for example, by “10”), but does not exceed the upper limit (for example, the initial value “100”), and the process returns to step STK1.

FIG. 21 is a flowchart explaining an example of the third process Pc″ in the flowchart depicted in FIG. 17. As depicted in FIG. 21, when the third process Pc″ in the flowchart of FIG. 17 starts, in step STL1, it is determined whether there is non-updated data in the extraction position list. If it is determined in step STL1 that there is non-updated data in the extraction position list (YES), the process proceeds to step STL2, where the data in the extraction position list is obtained, and the process proceeds to step STM11. Conversely, if it is determined in step STL1 that there is no non-updated data in the extraction position list (NO), the process proceeds to step STL3, where the data of the extraction position used in the operation is deleted, and the third process Pc″ ends. When the third process Pc″ ends, the process proceeds to step STF7 in the flowchart of FIG. 17 described above.

As depicted in FIG. 21, steps STM11 to STM15, STM21 to STM25, . . . , STMN1 to STMN5 are configured to perform similar processing for the respective conditions (settings) C1, C2, . . . , CN. Thus, in the following description, the processing for condition C1 (steps STM11 to STM15) will be described, but the same processing will also be performed for steps STM21 to STM25, . . . , STMN1 to STMN5, except that the target conditions are different.

Specifically, in step STM11, it is determined whether the non-updated data acquired from the extraction position list matches the condition C1, and if it is determined that it matches C1 (YES), the process proceeds to step STM12, and if it is determined that it does not match C1 (NO), the process proceeds to step STM21. If it does not match C1 in step STM11, it is determined in step STM21 whether it matches C2, and the same process is repeated to determine whether it matches CN in step STMN1, whereby processes for all conditions C1 to CN are performed.

In step STM12, the setting C1 is acquired, and the process proceeds to step STM13 to determine whether or not to delete the data in the extraction position list. If it is determined in step STM13 that the data in the extraction position list should not be deleted (NO), the process proceeds to step STM14. If it is determined that the data in the extraction position list should be deleted (YES), the process proceeds to step STM15.

In step STM14, the predetermined value C1 is added to the priority of the data in the extraction position list, and the process returns to step STL1. However, the priority addition process of step STM14 is performed so as not to exceed the upper and lower limits. In step STM15, the data in the extraction position list is deleted, and the process returns to step STL1. It should be noted that STM21 to STM25, . . . , STMN1 to STMN5 are the same as the processes in STM11 to STM15, except that the target conditions C2, . . . , CN are different from C1.

In this manner, in the third process Pc″ in the extraction machine control program of the third example, the priority of the data in the extraction position list is adjusted in accordance with the various conditions C (C1, C2, . . . , CN), and the extraction positions accessed by the industrial robot may be controlled. The following are examples of these conditions C. It should be noted that the conditions C are not limited to those listed below, and any combination of these and various other inferable changes and modifications may be made.

Specifically, as C, there are conditions such as the position of the workpiece of the data in the extraction position list and the position of the workpiece in the data of the extraction position used in the operation being within a predetermined distance, or the extraction position of the data in the extraction position list and the extraction position in the data of the extraction position used in the operation being within a predetermined distance. Furthermore, as C, there are also conditions such as no condition (applies in any case), when the operation is collapsing, when the operation is extraction, or when the operation is shifting.

Also, for example, when the operation is collapsing, the condition may be that the position of the workpiece in the data of the extraction position list and the position of the workpiece in the data of the extraction position used in the operation are within a predetermined distance, or that when the operation is collapsing, the extraction position in the data of the extraction position list and the extraction position in the data of the extraction position used in the operation are within a predetermined distance.

Similarly, when the operation is extraction, the condition may be that the position of the workpiece in the data of the extraction position list and the position of the workpiece in the data of the extraction position used in the operation are within a predetermined distance, or when the operation is extraction, the condition may be that the position of the workpiece in the data of the extraction position list and the position of the workpiece in the data of the extraction position used in the operation are within a predetermined distance. Furthermore, when the operation is shifting, the condition may be that the position of the workpiece in the data of the extraction position list and the position of the workpiece in the data of the extraction position used in the operation are within a predetermined distance, or when the operation is shifting, the condition may be that the extraction position in the data of the extraction position list and the extraction position in the data of the extraction position used in the operation are within a predetermined distance.

Furthermore, when the operation fails due to interference or inaccessibility, the condition may be that the extraction position in the data of the extraction position used in the operation is within a predetermined range from a predetermined position, or that the extraction position in the data of the extraction position used in the operation is within a predetermined range from the wall of the container. When the operation fails due to interference or inaccessibility, the condition may be that the extraction position in the data of the extraction position used in the operation is within a predetermined range from the top surface of the container, or that the extraction position in the data of the extraction position used in the operation is within a predetermined range from the bottom surface of the container.

For each of the settings C (C1, C2, . . . , CN), it is possible to determine, for example, either deleting the data of the corresponding extraction position list or lowering the priority by a predetermined value C1, C2, . . . , CN. For example, the contents of each of the settings C1, C2, . . . , CN may be changed in accordance with a predetermined condition. Specifically, an example of the contents being changed in accordance with a predetermined condition is changing the contents of the settings C1, C2, . . . , CN (conditions and priority of the extraction position to be selected) in accordance with the life count or visit count in the processing of the extraction machine control program of the first example described with reference to FIG. 3 to FIG. 8 and the processing of the extraction machine control program of the second example described with reference to FIG. 11 to FIG. 16.

Each of the predetermined values C1, C2, . . . , CN may be, for example, “−100”, “−20”, “0”, “10”, “100”, etc., and a variable in accordance with the distance from the extraction position used in the operation, etc., may be set as the predetermined value C1, C2, . . . , CN. Furthermore, each of the predetermined values C1, C2, . . . , CN may be changed in accordance with a predetermined condition. Specifically, an example of a value changing in accordance with a predetermined condition is changing the value of the predetermined value C1, C2, . . . , CN in accordance with the value of the life count or the visit count in the processing of the extraction machine control program of the first example described with reference to FIG. 3 to FIG. 8 and the processing of the extraction machine control program of the second example described with reference to FIG. 11 to FIG. 16.

FIG. 22 and FIG. 23 are flowcharts explaining an example of the fourth process Pd″ in the flowchart depicted in FIG. 17. As depicted in FIG. 22 and FIG. 23, when the fourth process Pd″ in the flowchart of FIG. 17 starts, in step STP1, it is determined whether or not there is non-updated data in the extraction position list. If it is determined in step STP1 that there is non-updated data in the extraction position list (YES), the process proceeds to step STP2, where the data in the extraction position list is obtained, and the process proceeds to step STQ11. Conversely, if it is determined in step STP1 that there is no non-updated data in the extraction position list (NO), the process proceeds to step STR11.

As depicted in FIG. 22 and FIG. 23, steps STQ11 to STQ15, STQ21 to STQ25, . . . , STQN1 to STQN5 are designed to perform similar processing for the respective conditions (settings) D1, D2, . . . , DN. Furthermore, steps STR11 to STR15, STR21 to STR25, . . . , STRN1 to STRN5 are designed to perform similar processing for the respective conditions DD1, DD2, . . . , DDN. Thus, in the following description, the processing for condition D1 (steps STQ11 to STQ15) and the processing for condition DD1 (steps STR11 to STR15) will be explained, but the same processing will be performed for steps STQ21 to STQ25, . . . , STQN1 to STQN5 and steps STR21 to STR25, . . . , STRN1 to STRQN5, except that the target conditions are different.

Specifically, in step STQ11, it is determined whether the non-updated data obtained from the extraction position list matches the condition D1, and if it is determined that it matches D1 (YES), the process proceeds to step STQ12, and if it is determined that it does not match D1 (NO), the process proceeds to step STQ21. If it does not match DI in step STQ11, it is determined in step STQ21 whether it matches D2, and the same process is repeated to determine whether it matches DN in step STQN1, whereby processing for all conditions D1 to DN is performed.

In step STQ12, setting D1 is obtained, and the process proceeds to step STQ13 to determine whether or not to delete the data in the extraction position list. If it is determined in step STQ13 that the data in the extraction position list should not be deleted (NO), the process proceeds to step STQ14. If it is determined that the data in the extraction position list should be deleted (YES), the process proceeds to step STQ25.

In step STQ14, a predetermined value D1 is added to the priority of the data in the extraction position list, and the process returns to step STP1. However, the priority addition process in step STQ14 is performed so as not to exceed the upper and lower limits. In step STQ15, the data is deleted from the extraction position list, and the process returns to step STP1. It should be noted that STQ21 to STQ25, . . . , STQN1 to STQN5 are the same as the processes in STQ11 to STQ15, except that the target conditions D2, . . . , DN are different from D1.

Next, in step STP1, if it is determined that there is no non-updated data in the extraction position list (NO), the process proceeds to step STR11, where it is determined whether or not the condition DD1 is met. If it is determined in step STR11 that DD1 is met (YES), the process proceeds to step STR12, and if it is determined that DD1 is not met (NO), the process proceeds to step STR21. If DD1 is not met in step STR11, it is determined in step STR21 whether or not DD2 is met, and the same process is repeated to determine whether DDN is met in step STRN1, whereby processing for all conditions DD1 to DDN is performed.

In step STR 12, the setting DD1 is obtained, and the process proceeds to step STR13 to determine whether or not the data in the extraction position list used in the operation is to be deleted from the extraction position list. If it is determined in step STR13 that the data is to be deleted from the extraction position list (YES), the process proceeds to step STR14, and if it is determined that the data is not to be deleted from the extraction position list (NO), the process proceeds to step STR15. In step STR14, the data of the extraction position used in the operation is deleted from the extraction position list, and the fourth process Pd″ ends. In step STR 15, a predetermined value DD1 is added to the priority of the data in the extraction position list, and the fourth process Pd″ ends. However, the priority addition process in step STR15 is performed so as not to exceed the upper and lower limit ranges. STR21 to STR25, . . . , STRN1 to STRN5 are the same as the processes of STR11 to STR 15, except that the target conditions DD2, . . . , DDN are different from DD1.

In this manner, in the fourth process Pd″ in the extraction machine control program of the third example, the priority of the data in the extraction position list is adjusted by various conditions D (D1, D2, . . . , DN) and DD (DD1, DD2, . . . , DDN) to control the extraction positions accessed by the industrial robot. The following are examples of these conditions D and DD. It should be noted that the conditions D and DD are not limited to those listed below, and any combination of these and various other changes and modifications that may be inferred are possible.

Specifically, as D, there are conditions such as the position of the workpiece of the data in the extraction position list and the position of the workpiece in the data of the extraction position used in the operation are within a predetermined distance, or conditions such as the extraction position of the data in the extraction position list and the extraction position in the data of the extraction position used in the operation are within a predetermined distance. Furthermore, as D, there are conditions such as such as no condition (applies in any case), when the operation is collapsing, when the operation is extraction, or when the operation is shifting.

For example, when the operation is collapsing, the condition may be that the position of the workpiece in the data of the extraction position list and the position of the workpiece in the data of the extraction position used in the operation are within a predetermined distance, or when the operation is collapsing, the condition may be that the extraction position in the data of the extraction position list and the extraction position in the data of the extraction position used in the operation are within a predetermined distance.

Similarly, when the operation is extraction, the condition may be that the position of the workpiece in the data of the extraction position list and the position of the workpiece in the data of the extraction position used in the operation are within a predetermined distance, or when the operation is extraction, the condition may be that the extraction position in the data of the extraction position list and the extraction position in the data of the extraction position used in the operation are within a predetermined distance. Furthermore, when the operation is shifting, the condition may be that the position of the workpiece in the data of the extraction position list and the position of the workpiece in the data of the extraction position used in the operation are within a predetermined distance, or when the operation is shifting, the condition may be that the extraction position in the data of the extraction position list and the extraction position in the data of the extraction position used in the operation are within a predetermined distance.

Furthermore, when the operation fails due to interference or inaccessibility, the condition may be that the extraction position in the data of the extraction position used in the operation is within a predetermined range from a predetermined position, or the extraction position in the data of the extraction position used in the operation is within a predetermined range from the wall of the container. Furthermore, the condition may be that the extraction position in the data of the extraction position used in the operation is within a predetermined range from the top surface of the container, or the extraction position in the data of the extraction position used in the operation is within a predetermined range from the bottom surface of the container.

For each of the settings D (D1, D2, . . . , DN), it is possible to determine either to delete the data in the corresponding extraction position list or to lower the priority by a predetermined value D1, D2, . . . , DN. The predetermined values D1, D2, . . . , DN are, for example, values such as “−100”, “−20”, “0”, “10”, and “100”. A variable corresponding to the distance from the extraction position used in the operation may be set as the predetermined value D1, D2, . . . , DN. The value of each of the predetermined values D1, D2, . . . , DN may be changed in accordance with a predetermined condition. Furthermore, changing the value in accordance with a predetermined condition may be, for example, controlling the priority of the data in each extraction position list in accordance with the life count or visit count in the processing of the extraction machine control program of the first and second examples described above.

Furthermore, DD (DD1, DD2, . . . , DDN) may be considered to be the same as C (C1, C2, . . . , CN) and D (D1, D2, . . . , DN) described above. Each of the predetermined values DD1, DD2, . . . , DDN may be, for example, a value such as “−100”, “−20”, “0”, “10”, “100”, etc. Alternatively, each of the predetermined values DD1, DD2, . . . , DDN may be, for example, a variable corresponding to the distance from a wall (a predetermined surface of the container 4). Each of the predetermined values DD1, DD2, . . . , DDN may be changed in value in accordance with a predetermined condition in the same manner as D1, D2, . . . , DN. Changing the value in accordance with a predetermined condition may be, for example, controlling the priority of the data in each extraction position list in accordance with the life count or visit count in the processing of the extraction machine control program of the first and second examples described above.

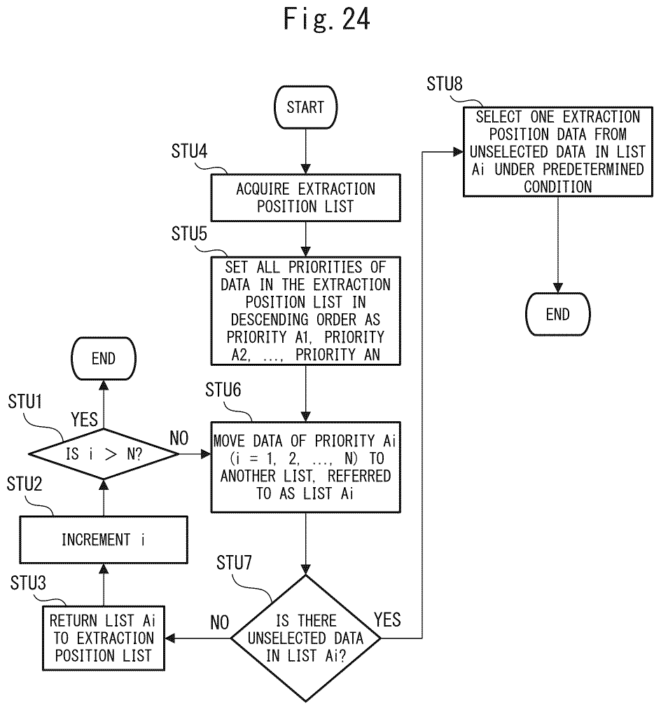

FIG. 24 is a flowchart explaining an example of a process for selecting data to be extracted from the extraction position list in accordance with priority in the extraction machine control program of the third example depicted in FIG. 17. As depicted in FIG. 24, when an example of a process for selecting data to be extracted from the extraction position list in accordance with priority starts, the extraction position list is acquired in step STU4, and the process proceeds to step STU5, where all priorities of data in the extraction position list are set in descending order as priority A1, priority A2, . . . , priority AN. The process then proceeds to step STU6, where data of priority Ai (i=1, 2, 3, . . . , N) is moved to another list (hereinafter referred to as list Ai), and the process proceeds to step STU7.

In step STU7, it is determined whether there is unselected data in list Ai, and if it is determined that there is unselected data (YES), the process proceeds to step STU8, and if it is determined that there is no unselected data (NO), the process proceeds to step STU3. In step STU8, one extraction position data is selected from the unselected data in list Ai under a predetermined condition, and the process ends. Selecting one extraction position data under a predetermined condition in step STU8 means selecting based on a certain index, for example, selecting the data with the largest Z coordinate value of the extraction position.

Conversely, in step STU3, list Ai is returned to the extraction position list, and the process proceeds to step STU2, where i is incremented. Specifically, the priority (selection order) is increased by one, so that the extraction position of the next priority may be selected. The process then proceeds to step STU1, where it is determined whether i>N. If it is determined that i>Nis not the case (NO), the process returns to step STU6. If it is determined that i>N is the case (YES), the process ends.

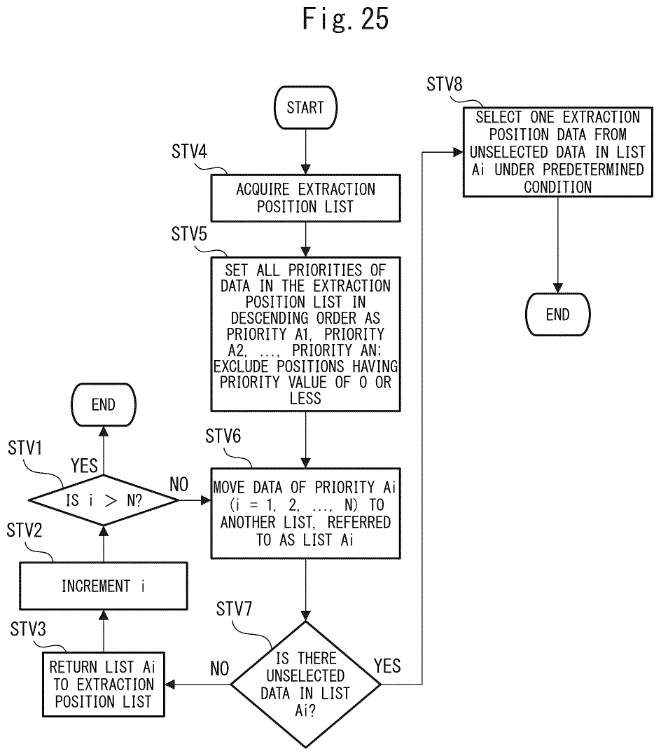

FIG. 25 is a flowchart explaining another example of the selection process of data to be extracted from the extraction position list in accordance with the priority in the extraction machine control program of the third example depicted in FIG. 17. As depicted in FIG. 25, when another example of the selection process of data to be extracted from the extraction position list in accordance with the priority starts, the extraction position list is acquired in step STV4, and the process proceeds to step STV5, where all priorities of data in the extraction position list are set to priorities A1, A2, . . . , AN in descending order. In the process of step STV5, those with a priority of “0” or less are excluded. It should be noted that the reason for excluding those with a priority of “0” or less is to enable data not to be selected as extraction position data to be specified by priority, and this process corresponds to, for example, the process of setting the priority of extraction position data included in the blacklist to “0” in the extraction machine control program of the first example.

The process then proceeds to step STV6, where data of priority Ai (i=1, 2, 3, . . . , N) is transferred to another list (hereinafter referred to as list Ai), and the process proceeds to step STV7. In step STV7, it is determined whether there is unselected data in list Ai, and if it is determined that there is unselected data (YES), the process proceeds to step STV8, and if it is determined that there is no unselected data (NO), the process proceeds to step STV3. In step STV8, one extraction position data is selected from the unselected data in list Ai under a predetermined condition, and the process ends. Selecting one extraction position data under a predetermined condition in step STV8 means selecting based on a certain index, for example, selecting the data with the largest Z coordinate value of the extraction position.

Conversely, in step STV3, list Ai is returned to the extraction position list, and the process proceeds to step STV2 where i is incremented. Specifically, the priority is increased by one, so that the extraction position of the next priority may be selected. The process then proceeds to step STV1 where it is determined whether i>N. If it is determined that i>N is not the case (NO), the process returns to step STV6. If it is determined that i>N is the case (YES), the process ends.

The extraction machine control program according to the present embodiment described above may be modified and altered in various ways in accordance with the specifications and requirements of the machine system to which the present embodiment is applied.

Note that the extraction machine control program according to the present embodiment described above may be recorded in a computer-readable non-temporary recording medium or non-volatile semiconductor storage device and provided, or may be provided via wired or wireless communication. Here, as a computer-readable non-temporary recording medium, for example, an optical disk such as a CD-ROM (Compact Disc Read Only Memory) or a DVD-ROM, or a hard disk device, and the like may be considered. Further, a PROM (Programmable Read Only Memory), a Flash Memory (registered trademark), and the like are conceivable as nonvolatile semiconductor memory devices. In addition, the distribution from the server device may be provided via a wired or wireless WAN (Wide Area Network), LAN (Local Area Network), or via the Internet.

As described in detail above, the extraction machine controller, extraction machine control program, and extraction machine system according to the present embodiment enable the efficient performance of object extraction.

Although the embodiments of the present disclosure have been described in detail, the present disclosure is not limited to the individual embodiments described above. These embodiments include various additions and replacements without departing from the gist of the invention, or without departing from the idea and spirit of the invention derived from the content described in the claims and equivalents thereof, modification, partial deletion, and the like are possible. For example, in the above-described embodiments, the order of each operation and the order of each process are shown as an example, and are not limited to these. The same applies when numerical values or equations are used in the description of the above-described embodiments.

1. An extraction machine controller for controlling an extraction machine and extracting an arbitrary object from a plurality of objects including at least one object on which a plurality of extraction positions are set, the controller comprising:
a data acquisition unit configured to acquire data from a sensor that measures an outer shape of the plurality of objects;
a data processing unit configured to process the data from the data acquisition unit and store in a list, for each of the extraction positions, data used for controlling the extraction machine to access the object in association with the extraction positions;
an extraction position selection unit configured to select an extraction position of an object to be extracted by the extraction machine based on an output of the list; and
an extraction machine control unit configured to control the extraction machine to extract the object based on an output of the extraction position selection unit.

2. The extraction machine controller according to claim 1, wherein the list is a blacklist in which there is stored extraction positions that the extraction machine is not allowed to access, and
the data processing unit is configured to store in the blacklist, for each of the extraction positions, at least one of an extraction position related to an extraction operation in which the extraction machine is controlled based on the extraction position to extract the object, and an extraction position other than the extraction position related to the extraction operation.

3. The extraction machine controller according to claim 2, wherein the data processing unit is further configured to:
set a visit count for the extraction position stored in the blacklist,
increase the visit count set for the extraction positions based on a first predetermined condition, and
delete the extraction position stored in the blacklist from the blacklist when the visit count set for the extraction position becomes equal to or greater than a predetermined value.

4. The extraction machine controller according to claim 2, wherein the data processing unit is further configured to:
set a life count for the extraction position of the object stored in the blacklist,
decrease the life count set for the extraction position based on a second predetermined condition, and
delete the extraction position stored in the blacklist from the blacklist when the life count set for the extraction position becomes zero or less.

5. The extraction machine controller according to claim 4, wherein the data processing unit is further configured to:
set a weight for a value by which the life count set for the extraction position is decreased based on a third predetermined condition.

6. The extraction machine controller according to claim 5, wherein the data processing unit is further configured to:
decrease the life count set for a first extraction position by a first value when a distance between the first extraction position stored in the blacklist and a second extraction position related to the extraction operation of the object is close, and
decrease the life count set for the first extraction position by a second value which is less than the first value when the distance between the first extraction position stored in the blacklist and the second extraction position related to the extraction operation of the object is farther than the close distance.

7. The extraction machine controller according to claim 2, wherein the data processing unit is further configured to:
when an object for which a new extraction position based on a new measurement is set overlaps with the position and orientation data of an object for which an extraction position already stored in the blacklist is set, perform at least one of taking over and using of the data of the extraction position already stored in the blacklist.

8. The extraction machine controller according to claim 2, wherein the data processing unit is further configured to:
when the new extraction position overlaps with the extraction position already stored in the blacklist, perform at least one of taking over and using the data of the extraction position already stored in the blacklist.

9. The extraction machine controller according to claim 7, wherein the data processing unit is further configured to:
delete the data of the extraction position already stored in the blacklist that has been inherited and/or used.

10. The extraction machine controller according to claim 1, wherein the list is an extraction position list in which there is stored a priority of being accessed by the extraction machine, and
the data processing unit is configured to decrease, by a predetermined value, the priority in the extraction position list of at least one of an extraction position related to an extraction operation for controlling the extraction machine to extract the object based on the extraction position and an extraction position other than the extraction position related to the extraction operation, for each of the extraction positions.

11. The extraction machine controller according to claim 10, wherein the data processing unit is further configured to:
set a visit count for an extraction position the priority of which has been decreased,
increase the visit count set for the extraction position based on a first predetermined condition, and
when the visit count set for the extraction position reaches or exceeds a predetermined value, return the priority of the extraction position the priority of which has been decreased to a predetermined value or deletes it from the extraction position list.

12. The extraction machine controller according to claim 10, wherein the data processing unit is further configured to:
set a life count for the extraction position the priority of which has been lowered,
decrease the life count set for the extraction position based on a second predetermined condition, and
when the life count set for the extraction position becomes equal to or less than zero, return the priority of the extraction position the priority of which has been decreased to a predetermined value or deletes it from the extraction position list.

13. The extraction machine controller according to claim 12, wherein the data processing unit is further configured to:
set a weight based on a third predetermined condition for a value by which the life count set in the extraction position is decreased.

14. The extraction machine controller according to claim 13, wherein the data processing unit is further configured to:
decrease the life count set for a first extraction position by a first value when a distance between the first extraction position having the decreased priority and the second extraction position related to the extraction operation of the object is close, and
decrease the life count set in the first extraction position by a second value which is less than the first value when the distance between the first extraction position having the lowered priority and the second extraction position related to the extraction operation of the object is farther than the close distance.

15. The extraction machine controller according to claim 13, wherein the data processing unit is further configured to:
integrate visit count processing and life count processing into the priority processing.

16. The extraction machine controller according to claim 10, wherein the data processing unit is further configured to:
when an object for which a new extraction position based on a new measure is set overlaps with position and orientation data of an object for which an extraction position having a lower priority is set, perform at least one of taking over and using the data of the extraction position with a lower priority.

17. The extraction machine controller according to claim 10, wherein the data processing unit is further configured to:
when the new extraction position overlaps with the extraction position having a lower priority, perform at least one of taking over and using the data of the extraction position having a lower priority.

18. The extraction machine controller according to claim 16, wherein the data processing unit is further configured to:
delete data of the extraction position having the lower priority which has been performed at least one of taking over and using the data of the extraction position having the lower priority.

19. The extraction machine controller according to claim 10, wherein the predetermined value is set to a value that makes the priority of the extraction position the priority of which has been lowered zero, and
the extraction position selection unit is configured not to select the extraction position the priority of which is zero.

20. The extraction machine controller according to claim 1, wherein the plurality of objects are randomly arranged in a container, and
the sensor is a three-dimensional measurement instrument configured to measure the outer shape of the plurality of objects randomly arranged in the container.

21-22. (canceled)
